(19) United States
(12) Patent Application Publication
(10) Pub. No.: US 2025/0044448 A1
(43) Pub. Date: Feb. 6, 2025

(54) ELECTRONIC DEVICE, METHOD AND COMPUTER PROGRAM

(71) Applicant: Sony Semiconductor Solutions Corporation, Kanagawa (JP)

(72) Inventors: Gerd SPALINK, Stuttgart (DE); Haruhiko TERADA, Kanagawa (JP)

(73) Assignee: Sony Semiconductor Solutions Corporation, Kanagawa (JP)

(21) Appl. No.: 18/718,445

(22) PCT Filed: Dec. 21, 2022
(86) PCT No.: PCT/EP2022/087236

§ 371 Date: Jun. 11, 2024

(30) Foreign Application Priority Data
Dec. 23, 2021 (EP) 21217373.6

(51) Int. Cl. G01S 17/58; G01S 7/481; G01S 7/4915; G01S 17/36; G01S 17/931

(52) U.S. Cl. CPC G01S 17/58; G01S 7/4818; G01S 7/4915; G01S 17/36; G01S 17/931

(57) ABSTRACT

A measurement system comprising circuitry configured to determine a phase noise cancelled speed measurement (SPD) based on interference of a chirping upper single sideband (CUSB) and a fiber delay reference (FDR) and based on interference of a chirping lower single sideband (CLSB) and the fiber delay reference (FDR).

### TECHNICAL FIELD

The present disclosure generally pertains to phase noise cancellation for a measurement system, e.g. frequency modulated continuous wave light detection and ranging system (FMCW Lidar), for measurements of a speed of a target object.

### TECHNICAL BACKGROUND

Lidar is a method for determining ranges (variable distance) by targeting an object with a laser and measuring the time for the reflected light to return to the receiver. The constant speed of light allows to determine distances based on the time for the reflected light to return to the receiver. The technology is known from mapping areas but is increasingly used in automotive applications such as advanced driver assistance systems or control and navigation for some autonomous cars. In this context a measurement system may be a ranging system.

### SUMMARY

According to a first aspect, the disclosure provides a measurement system comprising circuitry configured to determine a phase noise cancelled speed measurement based on interference of a chirping upper single sideband and a fiber delay reference and based on interference of a chirping lower single sideband and the fiber delay reference.

According to a further aspect, the disclosure provides a measurement method comprising determining a phase noise cancelled speed measurement based on interference of a chirping upper single sideband and a fiber delay reference and based on interference of a chirping lower single sideband and the fiber delay reference.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically shows an operation principle of Lidar system for measurement the distance of an object;

FIG. 2 schematically shows a conventional dual wavelength FMCW Lidar system for the evaluation of distance with compensation of phase noise;

FIG. 3 schematically shows an embodiment of a FMCW Lidar system for the measurement of speed of a target;

FIG. 4 schematically shows in more detail an embodiment of detection circuitry, as it is utilized in FIG. 3;

FIG. 5 schematically shows an embodiment of a processing algorithm carried out by a processor to measure a distance to a target and estimate the speed of the target using the FMCW Lidar system of FIGS. 3 and 4;

FIG. 6 schematically shows a processing algorithm carried out by a processor to estimate phase noise on signals of a FMCW Lidar system according to the embodiments of FIGS. 3, 4 and 5;

FIG. 7 schematically shows an embodiment of a processing algorithm to obtain the speed of the target using a FMCW Lidar system of FIGS. 3, 4, 5 and 6;

FIG. 8 schematically shows a FMCW Lidar system for the measurement of speed and distance of a target according to an embodiment;

FIG. 9a schematically shows a FMCW Lidar system for the measurement of speed and distance of a target according to an embodiment;

FIG. 9b schematically shows in more detail an embodiment of detection circuitry, as it is utilized in FIG. 9a;

FIG. 10 schematically shows a processing algorithm carried out by a processor to measure a distance to a target and estimate the speed of the target using the FMCW Lidar system according to the embodiments of FIG. 9a;

FIG. 11 schematically shows a processing algorithm carried out by a processor to estimate phase noise on signals of a FMCW Lidar system according to the embodiments of FIGS. 9a and 9b.

FIG. 12 schematically shows a processing algorithm to obtain the speed of the target using a FMCW Lidar system according to an embodiment of FIGS. 9a and 9b;

FIG. 13 schematically shows a flowchart of a distance measurement using a FMCW Lidar system, or according to an embodiment;

FIG. 14 schematically shows a flowchart of a speed measurement using a FMCW Lidar system according to an embodiment; and

FIG. 15 schematically describes an embodiment of an FMCW Lidar system device that can implement the processor for processing a distance and speed measurement of a target.

### DETAILED DESCRIPTION OF EMBODIMENTS

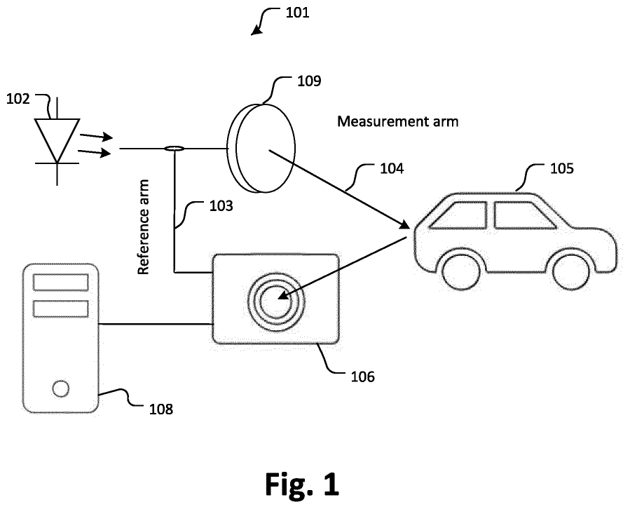

Before a detailed description of the embodiments under reference of FIGS. 1 to 15, general explanations are made.

The embodiments described below in more detail disclose a measurement system comprising circuitry configured to determine a phase noise cancelled speed measurement based on interference of a chirping upper single sideband and a fiber delay reference and based on interference of a chirping lower single sideband and the fiber delay reference.

The measurement system may for example be a laser ranging system that is, for example, based on the FMCW Lidar principle.

Ranging a target object is synonymous with locating a target object, e.g. based on sending a signal to a target object and receiving a return signal reflected at the target object. The ranging system may therefore be any system that measures the distance between a target object and itself. Further, a ranging system may also determine the speed of such a target object, either by tracking the measured distance over time or through an analysis of a doppler shifted that is caused by the target objects motion and is present in the return signal. The ranging system therefore may determine parameters such as relative or absolute positions, speeds, etc.

The measurement system described in the embodiments below in more detail may, for example, provide a FMCW Lidar that does not suffer from short coherence length caused by large linewidth of the laser source. Accurate detection of the distance of targets beyond the coherence length may become possible. In this way, the measurement systems described in the embodiments may apply low-cost lasers which have a coherence length in the order of a few meters. So, use of such lasers may become possible for automotive applications where distances in the order of several 100 meters have to be measured accurately. The phase noise cancellation may avoid phase noise that broadens the peak in the frequency domain, so that both accuracy and signal level are not lost.

The measurement system may for example be applied in an automotive context, e.g. in vehicles such as cars, trucks, etc.

The phase noise cancelled speed measurement may for example determine the speed of a target, such as other motorists, pedestrians, etc.

A chirping signal may be any signal in which the frequency increases (up-chirp) or decreases (down-chirp) with time.

A single sideband modulation or single-sideband suppressed-carrier modulation is a type of modulation used to transmit information.

The embodiments make use of an additional (fixed) reference path with a glass fiber link. The length of the glass fiber is preferably longer than the coherence length of the laser. The receiver components of reference path duplicate the ones in the target path, replacing the free-air transmission with a glass fiber link with a fixed length.

The fiber delay reference may for example be produced by any optical or opto-electronical circuitry that introduces a delay on an input signal. The delay may for example be generated by a fiber optic delay line, mirrors, etc.

Circuitry may include components such as electrical, electronical, opto-electronical, and optical components. The components may for example be photodiodes, lenses, fiber cables, lasers, receiver, processors, beam splitters, Mach-Zehnder interferometers, optical hybrids, balanced photo detectors, a memory (RAM, ROM or the like), interface, etc. and may be suitable for integration on a silicon photonics chip.

Interference may be generated by any circuitry that superimposes waves or electronic signals to form a resultant wave, or, respectively, electronic signal.

According to the embodiments, the chirping upper single sideband and the chirping lower single sideband are generated simultaneously.

In FMCW Lidar systems chirps are used that are significantly longer than the travel time of the light. For a target distance of 150 m, the travel time is 1 s. A chirp should preferably be longer than 10 μs to guarantee overlap of transmit and receive chirps of 9 μs. The generation of simultaneous up and down chirps increases the rate of measurement points over FMCW Lidar systems, that generate alternating up and down chirps.

Since up and down chirp are transmitted together, the system has twice the point rate of sequential up and down chirps.

Targets in automotive context may be moving targets. Preferably, both speed and distance can be measured accurately with the measurement systems described in the embodiments. This is typically achieved by sequential concatenation of up-chirps and down-chirps.

The chirping upper single sideband and the chirping lower single sideband may have anti-correlated signals and fully correlated phase noise.

According to the embodiments, transmit up-chirp and down-chirp are transmitted together in frequency domain multiplex. For example, a single mono-mode laser may generate light with limited coherence. This light is passed through an optical modulator modulated by an electrical mm-wave generator. The mm-wave generator generates chirp signals. The arrangement may ensure that the phase noise of up-chirp and down-chirp is fully correlated. The reflected up- and down-chirp signals are separated in the receiver. Signal processing can use the two signals to cancel both the phase noise and an arbitrary Doppler shift to retrieve an accurate distance estimation, which is equivalent to a delay time estimation.

The chirping upper single sideband and the chirping lower single sideband may be detected in separate balanced photo diodes.

The fiber delay reference may be obtained by a fiber delay configured to delay an input signal.

Preferably, the optical length of the fiber delay is greater than the coherence length of the chirping upper single sideband and the chirping lower single sideband.

The input signal may be obtained based on the chirping upper single sideband and the chirping lower single sideband.

The phase noise cancelled speed measurement may be obtained based on a phase noise estimate that is determined by interference of a chirping upper single sideband and the fiber delay reference and by interference of a chirping lower single sideband and the fiber delay reference.

The phase noise cancelled speed measurement may be obtained based on a fiber upchirp and a fiber downchirp, and a target delay value.

A phase noise cancelled speed measurement may for example be obtained based on phase noise estimate, wherein the phase noise estimate is determined based on a fiber upchirp and a fiber downchirp, and a target delay value, wherein the fiber upchirp is determined by interference of a chirping upper single sideband and a fiber delay reference and the fiber downchirp is determined by interference of a chirping lower single sideband and the fiber delay reference.

The measurement system may comprise a processor which determines the phase noise estimate. The processor can use phase noise cancellation using the same processing as in the target path to accurately estimate the delay time of the fiber. With the knowledge of the delay time of the fiber and the delay time of the target, the actual phase noise in the target path can be reconstructed using inverse and forward filters.

The phase noise may be subtracted from the target path to recover any Doppler frequency shift. Since the phase noise cancels for a distance measurement, a laser coherence requirement becomes more relaxed. The phase noise also approximately cancels for the speed measurement.

The circuitry may comprise an optical hybrid configured to combine the fiber delay reference with chirping upper single sideband or the fiber delay reference with the chirping lower single sideband, once directly and once with a 900 phase shift, to obtain an in-phase signal and a quadrature signal.

The chirping upper single sideband and the chirping lower single sideband may be generated by sideband modulation of a laser beam.

According to an embodiment, two single sideband optical modulation, driven by a linearly chirping electrical signal generate the chirping upper single sideband and the chirping lower single sideband.

The phase noise cancelled speed measurement may be obtained based on the phase noise estimate, a shifted target upchirp signal and a shifted target downchirp signal, wherein the shifted target upchirp signal and the shifted target downchirp signal are determined by shifting a target upchirp signal and, respectively, a target downchirp signal.

The fiber delay reference may be determined based on delaying a signal comprising the chirping upper single sideband and the chirping lower single sideband.

The laser beam may for example be generated by a distributed-feedback semiconductor laser.

The target upchirp signal may be shifted by mixing the target upchirp signal with a complex conjugated generated upchirp and downchirp signal and the target downchirp signal is shifted by mixing the target downchirp signal with a generated upchirp and downchirp signal.

The target upchirp signal may be determined by interference of a chirping upper single sideband and a reflection signal and the target downchirp signal is determined by interference of a chirping lower single sideband and the reflection signal.

The chirping upper single sideband and the chirping lower single sideband may be generated by sideband modulation of a laser beam.

The reflection signal may for example be determined based on reflecting a signal comprising the chirping upper single sideband and the chirping lower single sideband off a target.

The phase noise cancelled speed measurement may for example be obtained based on mixing the shifted target upchirp signal with a generated phase noise signal, which is based on the phase noise estimate, and based on mixing shifted target downchirp signal with the generated phase noise signal, which is based on the phase noise estimate.

The phase noise estimate may be determined based on a fiber delay phase noise and a target delay value, wherein the fiber delay phase noise is determined based on a shifted fiber upchirp signal and a fiber delay value.

The phase noise estimate may be determined based on a fiber delay phase noise and a target delay value, wherein the fiber delay phase noise is determined based on a shifted fiber downchirp signal and a fiber delay value.

The fiber delay value may be determined based on the fiber upchirp signal and the fiber downchirp signal.

The shifted fiber upchirp signal may be determined based on the fiber upchirp signal and the fiber downchirp signal, and wherein the shifted fiber downchirp signal is determined based on the fiber upchirp signal and the fiber downchirp signal.

The circuitry may further comprise a processor configured to analyse digital signals from a measurement path and reference paths and obtain a distance and a speed of a target as well as a phase noise of the laser beam.

The processor may for example be implemented as integrated circuit logic, for example, on a chip, and functionality provided by processes, units and entities described in the embodiments can, if not stated otherwise, be implemented by software.

A measurement system comprising circuitry configured to determine a distance to and a phase noise cancelled speed measurement of a target object based on interference of a chirping upper single sideband and a fiber delay reference and based on interference of a chirping lower single sideband and the fiber delay reference.

The measurement system can be configured as described above for the measurement system comprising circuitry configured to determine a distance to and a phase noise cancelled speed measurement of a target object.

The embodiments also disclose a measurement method comprising determining a phase noise cancelled speed measurement based on interference of a chirping upper single sideband and a fiber delay reference and based on interference of a chirping lower single sideband and the fiber delay reference.

The measurement method can be configured as described above for the measurement method comprising determining a phase noise cancelled speed measurement and the measurement system comprising circuitry configured to determine a distance to and a phase noise cancelled speed measurement of a target object.

FIG. 1 schematically shows an operation principle of Lidar system 101 for measuring the distance of an object 105.

A laser diode 102 unit emits a laser beam. The laser beam emitted by the laser diode 102 is split into two parts. A first part is transmitted to an optics 109 and a second part is transmitted to a detection unit 106.

The optics 109 transmits the laser beam emitted by the laser diode 102 and targets it an object 105. The laser beam targeted at the object 105 is reflected at the object 105. A detection unit 106 detects the laser beam, that is reflected at the object 105. The path of the first part of the laser beam transmitted by an optics 109, targeted at an object 105, reflected at the object 105 and detected by the detection unit 106 is commonly referred to as the measurement arm 104 (hereinafter also measurement path).

The detection unit 106 also detects the second part of the laser beam emitted by the laser diode 102. This path of the second part of the laser light from the laser diode 102 to the detection unit 106 is commonly referred to as the reference arm 103 (hereinafter also reference path). The detection unit 106 detects the laser beam of the measurement arm 104 and converts the signal of the laser beam into a digital signal. The detection unit 106 also detects laser beam of the reference arm 103 and converts these laser beam signal to digital signal. The detection unit then transmits those digital signals to the processing unit 108.

The processing unit processes the digital signal from the measurement arm 104 and the reference arm 103 and estimates a time delay between the signals. The time delay is due to different distances for the laser beams to travel in the measurement arm and the reference arm. Thus, the time delay between the signals of the measurement arm 104 and the reference arm 104 is indicative of the distance between the object 105 and the lidar system 101 including the optics 109 and detection unit 106. A greater distance between the object 105 and the lidar system 101 increases the measurement arm 104 and therefore the time delay. By measuring the time delay the object 105 can be ranged.

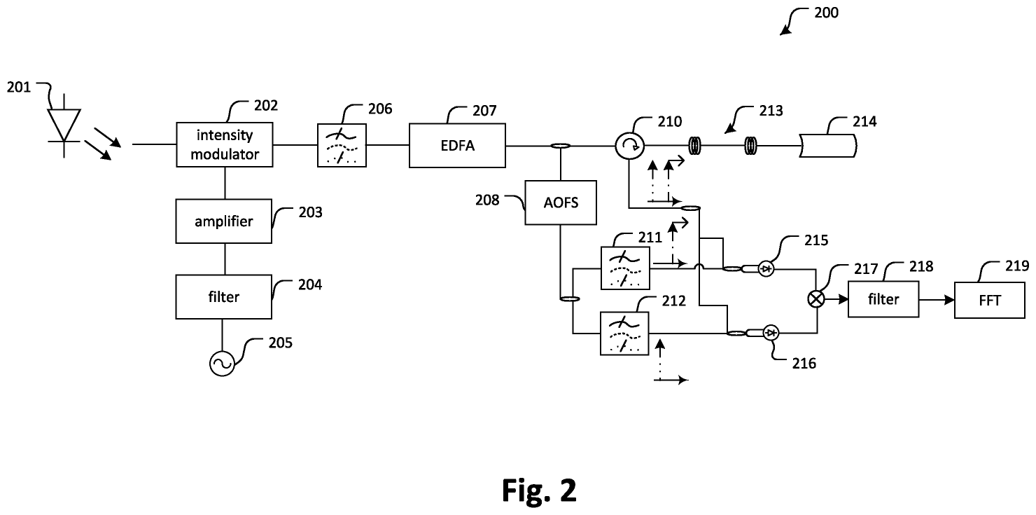

The time delay between the reference arm 103 and measurement arm 104 can e.g. be measured by periodically modulation the emitted laser beam with a certain frequency and detecting the phase shift of the modulation of the laser beam between the laser beam signals of the measurement path and the reference path. How frequency modulated light signal is generated and the phase shift of the light signals is detected in the prior art is shown in more detail in FIG. 2.

FIG. 2 schematically shows a conventional dual wavelength FMCW Lidar system for the evaluation of phase noise.

A distributed-feedback semiconductor laser 201 emits a laser beam with a linewidth of about 20 kHz, to generate a light signal. The laser beam is coupled into an intensity modulator 202, e.g. a Mach-Zehnder type intensity modulator. The intensity modulator 202 also receives an electrical signal, that is linearly frequency chirped over 1 GHz of range, from a Fractional-N microwave synthesiser 205. The Fractional-N microwave synthesiser 205 generates the electrical signal and transmits it to a filter 204 to obtain a filtered signal. An amplifier 203 amplifies the filtered signal to obtain an amplified filtered signal, that is linearly frequency chirped over 1 GHz of range (linearly frequency chirped electrical signal).

The laser beam is intensity modulated in the intensity modulator 202 by the linearly frequency chirped electrical signal generated by the Fractional-N microwave synthesiser 205, generating an upper sideband to the frequency of the laser beam. The sideband has a frequency difference to the frequency of the laser beam light that is always equal to a current frequency of the linearly frequency chirped signal. Thus, the sideband chirps as well, over 1 GHz of range.

After the sidebands are generated in the intensity modulator 202 the laser beam which includes the sidebands in addition to the carrier frequency of the laser is coupled into an optical band pass filter (OBPF) 206. The optical band pass filter 206 only transmits the carrier frequency and a single upper sideband that is closest in frequency to the carrier frequency, i.e., the 1^{st} order upper sideband. An Erbium-doped fiber amplifier (EDFA) 207 amplifies the laser beam that now includes the constant carrier frequency and the chirping 1^{st} order upper sideband, to obtain the generated light signal.

The light signal generated by the Erbium-doped fiber amplifier 207 is then split into two parts. A first part of the light signal generated by the Erbium-doped fiber amplifier 207 is transmitted to an acousto-optical frequency shifter (AOFS) 208 (reference arm), and a part of the light signal generated by the Erbium-doped fiber amplifier 207 is transmitted to a spool of a single mode fiber 213 (measurement arm). To simulate long distance measurement, the part of the generated light signal in the measurement arm passes through the spool of a single mode fiber 213, is reflected at a reflection mirror 214, and then again passes the spool of the single mode fiber 213 in reverse direction. The part of the generated light signal returning from the measurement arm is first split and then coupled to the balanced photo diodes 215 or 216, respectively.

During detection, heterodyne mixing of two signals having different frequencies is performed. Therefore, the frequency of the part of the light signal in the reference arm is shifted by the acousto-optical frequency shifter (AOFS) 208, which is driven by e.g. 40 MHz. The part of the light signal that has been shifted by the acousto-optical frequency shifter (AOFS) 208 is then split into two parts. A first part of the light signal that has been shifted by the acousto-optical frequency shifter 208 is passed through an optical band pass filter 211 and is then coupled to a balanced photo diode 215. A second part of the light signal that has been shifted by the acousto-optical frequency shifter 208 is passed through an optical band pass filter 212 and is then coupled to a balanced photo diode 216.

For detection of the light signal part returning from the measurement arm and a part in the reference arm are interfered before being input into the balanced photo detectors 215 and 216. The beat frequencies generated by this interference and measured by the balanced photo detectors 215 and 216 are mixed and filtered in a mixer 217 and a filter 218, respectively. Finally, a fast Fourier Transformation 219 is performed on the signal filtered by filter 218 to obtain a difference in distance between the reference and the measurement arm.

The conventional dual wavelength FMCW Lidar system for the measurement of distances described with regard to the embodiment of FIG. 2 above, is also described by M. Pu, W. Xie, L. Zhang, Y. Feng, Y. Meng, J. Yang, H. Zhou, Y. Bai, T. Wang, S. Liu, Y. Ren, W. Wei, and Y. Dong, in the published paper “Dual-Heterodyne Mixing Based Phase Noise Cancellation for Long Distance Dual-Wavelength FMCW Lidar,” in Optical Fiber Communication Conference (OFC) 2020, OSA Technical Digest (Optical Society of America, 2020), paper Th1K.2.

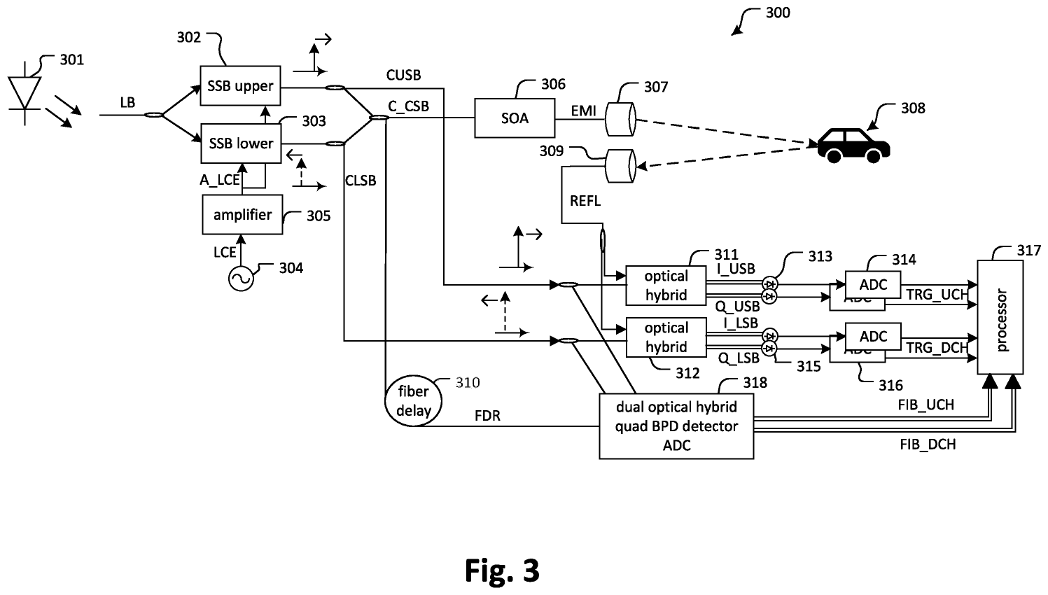

FIG. 3 schematically shows an embodiment of a FMCW Lidar system 300 for the measurement of speed of a target 308.

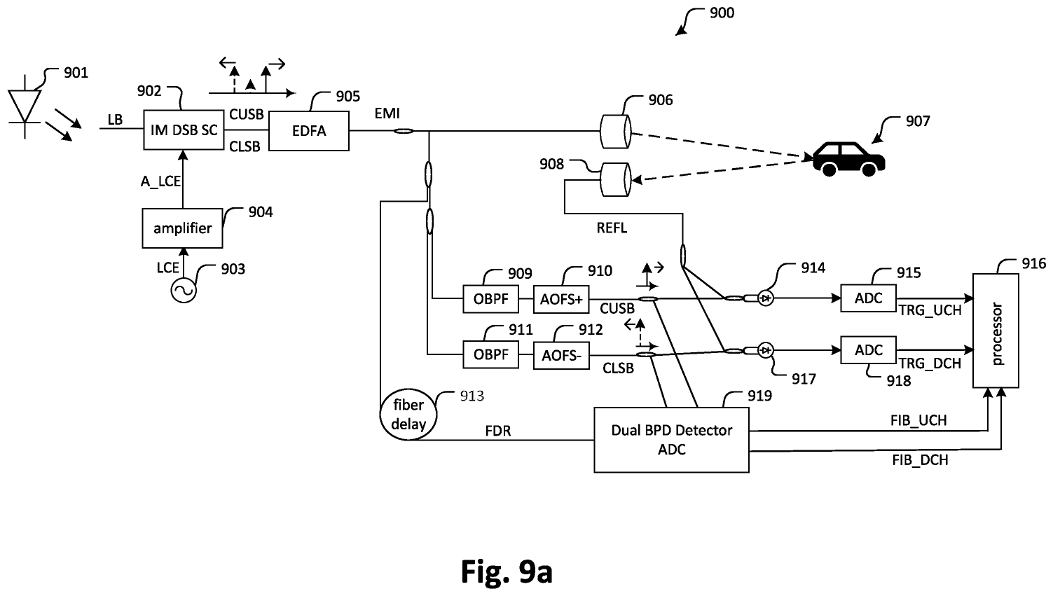

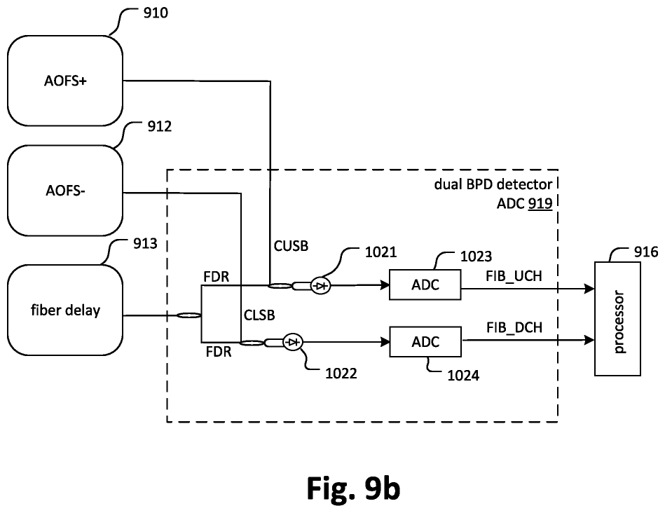

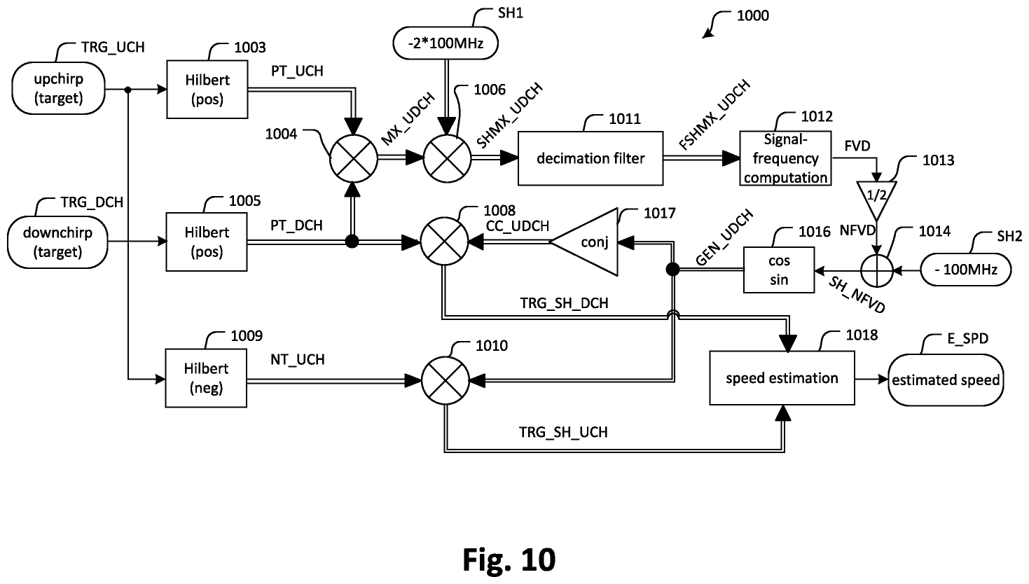

FMCW Lidar system 300 generates lower and upper sideband separately from the common laser and common chirp generator sources. These lower and upper sideband signals can be directly used as local oscillator signal in the coherent receive elements. The transmit signal is the sum of the two single side band signals, so it is a double-side band signal with suppressed carrier as in a FMCW Lidar system of FIG. 9 or 10.

The coherent receive elements in FMCW Lidar system 300 and FMCW Lidar system of FIG. 9 are optical hybrids that generate two outputs for I (In-phase) and Q (Quadrature) components. These outputs can be processed as a complex-valued signal. Eight balanced photodetectors are required for the whole system (I and Q, up-chirp and down-chirp, target and reference path).

A distributed-feedback semiconductor laser 301 generates a laser beam LB with a carrier frequency having a linewidth of e.g. 10 MHz and transmits the laser beam LB to an upper single sideband modulation (SSB) 302 and a lower single sideband modulation 303, respectively. A Frequency generator 304 generates a linearly chirped electrical signal LCE that chirps e.g. from 24 GHz to 25 GHz over a 20 μs time period and transmits it to an amplifier 305. The amplifier 305 amplifies the linearly chirped electrical signal LCE, to obtain an amplified linearly chirped electrical signal A_LCE.

Both, the upper single sideband modulation 302 and the lower single sideband modulation 303 receive the laser beam LB from the distributed-feedback semiconductor laser 301 and the amplified linearly chirped electrical signal A_LCE as inputs. The upper single sideband modulation 302 outputs a 1^{st} order upper sideband CUSB that chirps e.g. from carrier frequency plus 24 GHz up to carrier frequency plus 25 GHz, to obtain an upchirp. Similarly, the lower single sideband modulation 303 outputs a 1^{st} order lower sideband CLSB that chirps e.g. from carrier frequency minus 24 GHz down to carrier frequency minus 25 GHz, to obtain a downchirp.

Upper single sideband modulation 302 and lower single sideband modulation 303 modulate the laser beam LB of the distributed-feedback semiconductor laser 301 with the amplified linearly chirped electrical signal A_LCE. Through methods like intensity modulation and bandpass filtering, the Hartley method, or the Weaver method either an upper or a lower sideband are created. Finally, the carrier frequency can be suppressed. The upper single sideband modulator 302 and the lower single sideband modulator 303 can simultaneously generate the chirping upper sideband CUSB and the chirping lower sideband CLSP. The simultaneously generated chirping upper sideband CUSB and the chirping lower sideband CLSP have anti-correlated signal phases and fully correlated phase noise.

After being emitted from the upper single sideband modulation 302 the chirping upper sideband CUSB is split into two parts. Similarly, after being emitted from the lower single sideband modulation 303 the chirping lower sideband CLSB is split into two parts. The first parts of the chirping upper sideband CUSB and the chirping lower sideband CLSB are transmitted separately. The second parts of the chirping upper sideband CUSB and the chirping lower sideband CLSB are combined to obtain combined chirping sidebands C_CSB.

A semiconductor optical amplifier (SOA) 306 amplifies the combined chirping sidebands C_CSB to obtain the amplified upchirp and downchirp as an emittance signal EMI. An optics 307 emits the emittance signal EMI onto the target 308, where it is reflected, thus obtaining the reflected signal REFL. Another optics 309 receives the reflected signal REFL and outputs the reflected signal REFL to optical hybrids 311 and 312.

When the emittance signal EMI, emitted from the optics 307 is reflected on the target, becoming the reflected signal REFL, and is received by the optics 309 the distance to the target has imparted a time delay onto the reflected signal REFL relative to the reference chirping upper sideband CUSB and the reference chirping lower sideband CLSP. If the target is moving relative to the FMCW Lidar system 300, the target can also impart a shift in frequency onto the reflected signal due to the Doppler effect.

Optical hybrid 311 combines the reflected signal REFL from the optics 309 and the chirping upper sideband CUSB from the upper single sideband modulation 302 as a reference upchirp, once directly and once with a 90°-phase shift, to obtain an in-phase signal I_USB of the upper sideband and, respectively, a quadrature signal Q_USB of the upper sideband. Two balanced photo diodes 313 convert the in-phase signal I_USB and quadrature signal Q_USB into respective electrical signals. Analog-to-digital converters (ADC) 314 convert the electrical signals into respective digital signals.

Optical hybrid 312 combines the reflected signal REFL from the optics 309 and the chirping lower sideband CLSP from the lower single sideband modulation 303, as a reference downchirp, once directly and once with a 90°-phase shift, to obtain an in-phase signal I_LSB of the lower sideband and a quadrature signal Q_LSB of the lower sideband. Two balanced photo diodes 315 convert the in-phase signal I_LSB and quadrature signal Q_LSB into respective electrical signals. Analog-to-digital converters (ADC) 316 convert the respective combined electrical signals into respective digital signals.

The time delay of the reflected signal causes the chirping upper sideband CUSB and the chirping lower sideband CLSP of the reflected signal to lag behind the reference chirping upper sideband CUSB and the reference chirping lower sideband CLSP of the upper single sideband modulation 302 and lower single sideband modulation 303 respectively, which are input into the optical hybrids 311 and 312. The chirping upper sideband CUSB of the reflected signal is at lower frequency than the reference chirping upper sideband CUSB input into the optical hybrid 311. This is due to the increasing frequency of the chirping upper sideband CUSB. When the chirping upper sideband CUSB of the reflected signal and the reference chirping upper sideband CUSB are interfered a beat frequency develops. This beat frequency is indicative of the distance to the target and the doppler shift.

Non-zero target speeds produce an additional effect on the reflected chirping lower sideband CLSP and the reference chirping lower sideband CLSP. The Doppler effect shifts the frequencies of the reflected chirping upper sideband CUSB and chirping lower sideband CLSP in the same direction. Thus, the frequency difference between either the reflected and the reference chirping upper sideband CUSB decreases while the difference between the reflected and the reference chirping lower sideband CLSP increases or vice versa.

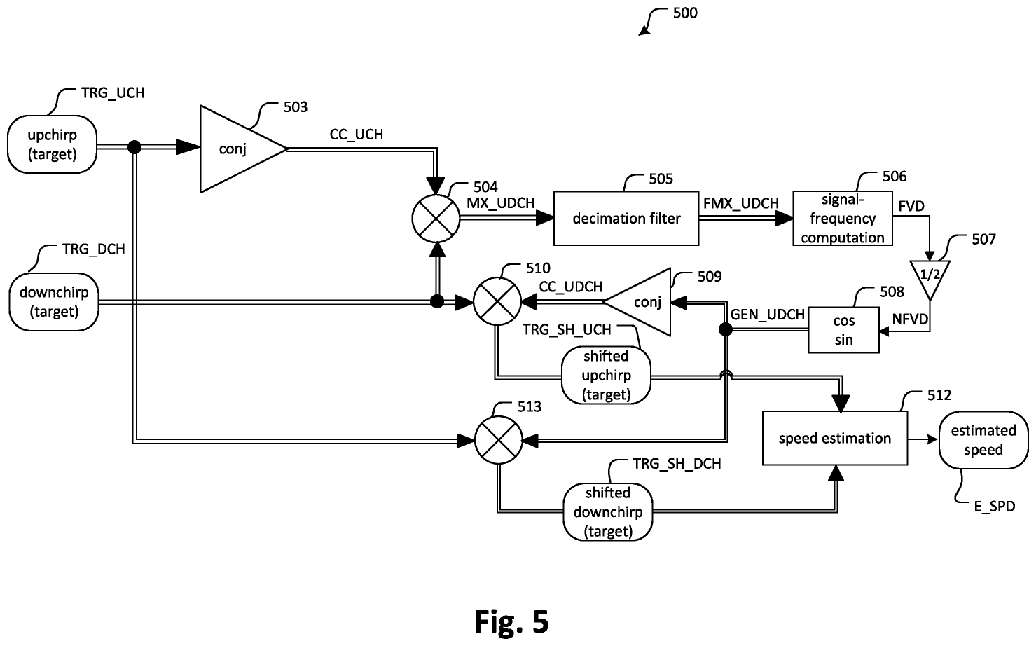

The digital signals obtained from analog-to-digital converters (ADC) 314, 316 are transmitted to the processor 317, as a target upchirp signal TRG_UCH and a target downchirp signal TRG_DCH. The target upchirp signal TRG_UCH and the target downchirp signal TRG_DCH are further processed by processor a 317 in order to determine the distance and the relative speed of target 308. Examples of the processing of the digital signals by processor 317 are explained in more detail below with regard to FIGS. 5 to 8.

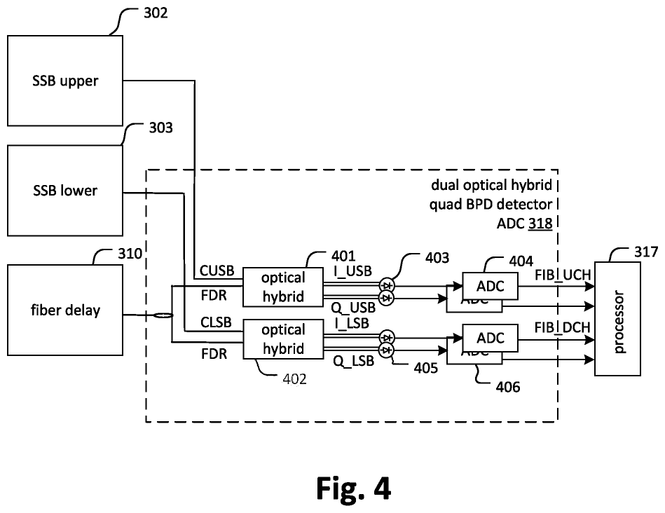

A fiber delay 310 receives the combined chirping sidebands C_CSB from the upper single sideband modulator 302 and the lower single sideband modulator 303 and obtains combined chirping sidebands C_CSB with a defined time delay as fiber delay reference FDR. In a detection circuitry 318 detection similar to the detection of the components 311 to 316 is performed. Dual optical hybrids combine either the reference chirping upper sideband CUSB or the reference chirping lower sideband CLSP with the fiber delay reference FDR from the fiber delay 310. Balanced photo diodes (BPD) convert the combined signals into respective electrical signals and analog-to-digital converters (ADC) convert the electrical signals into respective digital signals. The digital signals are transmitted to the processor 317. The exemplifying detection performed within the detection circuitry 318 is described with regard to FIG. 4 below. The fiber delay reference FDR form the fiber enables a reference measurement of phase noise in the processor 317. Thus, it is possible to calculate and subtract the phase noise that emerges in the processing of the reflected chirping upper sideband CUSB and the chirping lower sideband CLSP.

With the FMCW Lidar system 300 it is possible to measure both the distance and the relative speed of a target as will be described with reference to FIGS. 5 to 8, 11, 12 and 13.

FIG. 4 schematically shows in more detail an embodiment of detection circuitry 318, as it is utilized in FIG. 3

Optical hybrid 401 combines the fiber delay reference FDR from the fiber delay 310 and the chirping upper sideband CUSB from the upper single sideband modulation 302 as a reference upchirp, once directly and once with a 90°-phase shift, to obtain an in-phase signal I_USB of the upper sideband and a quadrature signal Q_USB of the upper sideband. Balanced photo diodes 403 convert these in-phase signal I_USB and quadrature signal Q_USB into respective electrical signals. Analog-to-digital converters (ADC) 404 convert the electrical signals into respective digital signals and transmit the digital signals to the processor 317

Optical hybrid 402 receives the fiber delay reference FDR from the fiber delay 310 and the chirping lower sideband CLSB from the lower single sideband modulation 303, as a reference downchirp. Optical hybrid 402 combines the fiber delay reference FDR and the chirping lower sideband CLSB, once directly and once with a 90°-phase shift, to obtain an in-phase signal I_LSB of the lower sideband and a quadrature signal Q_LSB of the lower sideband. Balanced photo diodes 405 convert the in-phase signal I_LSB and the quadrature signal Q_LSB into respective electrical signals. Analog-to-digital converters (ADC) 406 convert the electrical signals into respective digital signals and transmit the digital signals to the processor 317

The digital signals obtained from analog-to-digital converters (ADC) 314, 316 are transmitted to the processor 317 as a fiber upchirp FIB_UCH and a fiber downchirp FIB_DCH. The fiber upchirp FIB_UCH and the fiber downchirp FIB_DCH further processed by processor a 317 in order to determine a phase noise estimate to cancel the phase noise in the measurement of the distance and the relative speed of target 308. Examples of the processing of the digital signals by processor 317 are explained in more detail below with regard to FIGS. 5 to 8.

Fiber delay reference FDR from the fiber delay 310 and the chirping upper sideband CUSB from the upper single sideband modulation 302 as a reference upchirp do not interfere upon being combined since the coherence length of the signals is smaller than the delay introduced by the fiber delay 310. This makes it possible to extract the phase noise introduced by the distributed-feedback semiconductor laser 301 (or 901 in FIG. 9).

In general, the detection performed in the detection circuitry 318 is the same as the detection performed by the components 311 to 316 in FIG. 3.

FIG. 5 schematically shows an embodiment of a processing algorithm 500 carried out by a processor (317 in FIG. 3) to measure a distance to a target and estimate the speed of the target using the FMCW Lidar system 300 of FIGS. 3 and 4.

A target upchirp TRG_UCH and a target downchirp TRG_DCH are inputs to the processing algorithm 500. The inputs are provided, as can be seen in FIG. 3, by the ADCs 314 and 316 to the processor 317. The doubled arrows signify that the transmitted signal has an in-phase (I) and a quadrature (Q) component.

The upchirp TRG_UCH is complex conjugated 503, to obtain a complex conjugated upchirp CC_UCH. A mixer 504 mixes the complex conjugated upchirp CC_UCH with the downchirp TRG_DCH to obtain a mixed upchirp-downchirp MX_UDCH. A decimation filter 505 filters the mixed upchirp-downchirp MX_UDCH to obtain a filtered mixed upchirp-downchirp FMX_UDCH. A signal-frequency computation 506 computes the frequency of the filtered mixed upchirp-downchirp FMX_UDCH e.g. by transforming the filtered mixed upchirp-downchirp FMX_UDCH with a fast Fourier Transformation, finding the frequency peak and determining the central frequency of the frequency peak. The signal-frequency computation 506 obtains a frequency value FVD indicative of twice the distance to target. A normalizing step 507 normalizes the frequency value FVD to the sample rate to obtain a normalized frequency value NFVD indicative of the distance to target. The frequency value FVD and the normalized frequency value NFVD can further be used to compute the distance from the FMCW Lidar system (300 in FIGS. 3 and 4) to the target object (308 in FIG. 3).

A function generator 508 generates, based on normalized frequency value NFVD, an upchirp-downchirp signal representative of the range-to-target with decreased noise, as a generated upchirp-downchirp GEN_UDCH. The generated upchirp-downchirp GEN_UDCH is complex conjugated 509 to obtain a complex conjugated generated upchirp-downchirp CC_UDCH.

A mixer 510 mixes the complex conjugated generated upchirp-downchirp CC_UDCH with the downchirp TRG_DCH to obtain the shifted target downchirp TRG_SH_DCH. Similarly, a mixer 513 mixes the generated upchirp-downchirp GEN_UDCH with the upchirp TRG_UCH to obtain the shifted target upchirp TRG_SH_UCH.

A speed estimation 512 estimates, based on the shifted upchirp TRG_SH_UCH and the shifted downchirp TRG_SH_DCH, the speed of the target, obtaining the estimated speed SPD.

As described with reference to FIG. 3, the upchirp TRG_UCH and a downchirp TRG_DCH both contain a beat frequency indicative of the time delay between the reflected signal from the optic 309 and the upchirp from the upper single sideband modulation 302 as a reference upchirp or the downchirp from the lower single sideband modulation 303 as a reference downchirp. This beat frequency is averaged in the mixer 504 and extracted in the signal-frequency computation 506, e.g. by transforming the averaged beat frequency with a fast Fourier Transformation, finding the frequency peak and determining the central frequency of the frequency peak. The normalized frequency value NFVD indicative of a distance to target is determined based on the beat frequency. The function generator 508 generates a signal with the same beat, that is however reduced in noise as the generated upchirp-downchirp GEN_UDCH.

The mixer 510 mixes the complex conjugated generated upchirp-downchirp CC_UDCH with the downchirp TRG_DCH. The beat frequency indicative of the time delay between the reflected signal from the optics (309 in FIG. 3) and the downchirp TRG_UCH from the lower single sideband modulation (303 in FIG. 3), as a reference downchirp, and containing a frequency shift due to the Doppler effect is mixed with the complex conjugated generated upchirp-downchirp CC_UDCH without a frequency shift due to the Doppler effect. The resulting shifted downchirp TRG_SH_DCH has a further beat frequency that is indicative of the Doppler shift due to the target's speed. This is similarly the case for the shifted upchirp TRG_SH_UCH.

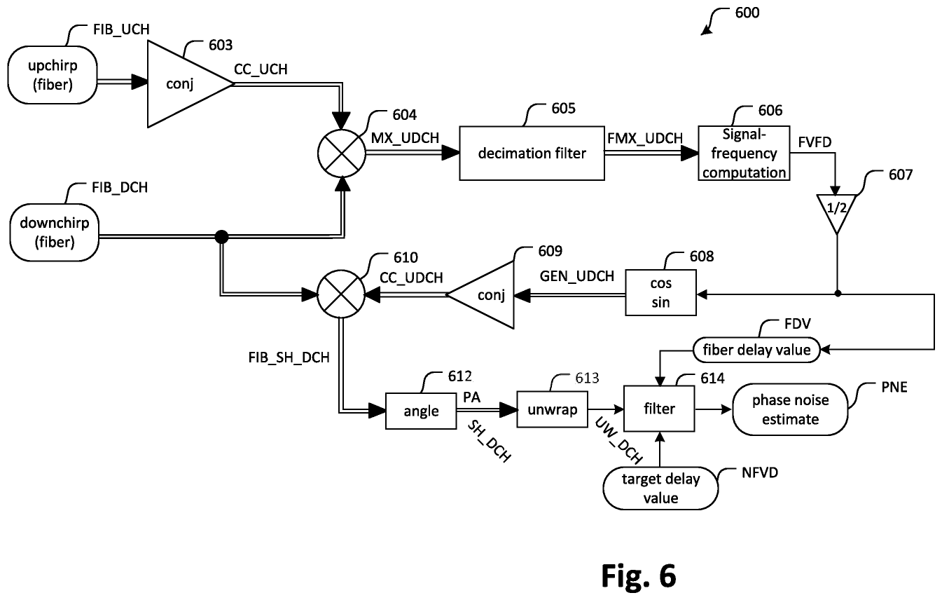

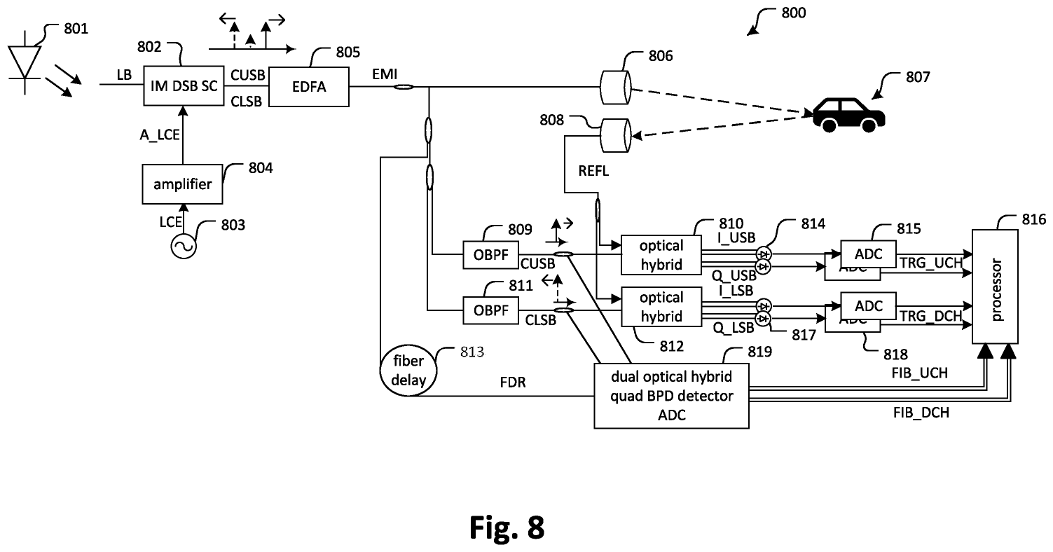

The speed estimation 512 can extract the frequencies indicative of the Doppler shift, e.g. via a fast Fourier Transformation, and estimates a speed from this frequency to obtain an estimated Speed E_SPD. The speed estimation 512 is not the final result but can be improved upon by determining and cancelling phase noise of the shifted target upchirp TRG_SH_UCH and the shifted target downchirp TRG_SH_UCH as exemplified in FIGS. 6 and 8.

FIG. 6 schematically shows a processing algorithm 600 carried out by a processor (317 in FIG. 3) to estimate phase noise on signals of a FMCW Lidar system 300 according to the embodiments of FIGS. 3, 4 and 5. In this embodiment, the processor uses phase noise cancellation using the same processing as in the target path to accurately estimate the delay time of the fiber. Thus, influences on the delay time such as the refractive index of the fiber changing with the temperature can be measured to improve the systems accuracy and reliability.

A fiber upchirp FIB_UCH and a fiber downchirp FIB_DCH from the fiber delay (310 in FIG. 3) are inputs to the processing algorithm 600. The inputs are provided, as can be seen in FIG. 4, by the ADCs 404 and 406 to the processor 317. The doubled arrows signify that the transmitted signal has an in-phase (I) and a quadrature (Q) component.

The upchirp FIB_UCH is complex conjugated in 603 to obtain a complex conjugated upchirp CC_UCH. A mixer 604 mixes the complex conjugated upchirp CC_UCH with the downchirp FIB_DCH to obtain a mixed upchirp-downchirp MX_UDCH. A decimation filter 605 filters the mixed upchirp-downchirp MX_UDCH to obtain a filtered mixed upchirp-downchirp FMX_UDCH. A signal-frequency computation 606 computes the frequency of the filtered mixed upchirp-downchirp FMX_UDCH, e.g. by transforming the filtered mixed upchirp-downchirp FMX_UDCH with a fast Fourier Transformation, finding the frequency peak and determining the central frequency of the frequency peak. The signal frequency computation 606 obtains a frequency value FVFD indicative of the delay introduced by the fiber delay (310 in FIG. 3). A normalizing step 607 normalizes the frequency value FVFD to obtain a fiber delay value FDV. The frequency value FVFD and the normalized frequency value NFVFD can further be used to compute the length of the delay fiber (310 in FIG. 3).

A function generator 608 generates a upchirp-downchirp representative of the fiber delay value FDV with decreased noise, as a generated upchirp-downchirp GEN_UDCH. The generated upchirp-downchirp GEN_UDCH is complex conjugated 609 to obtain a complex conjugated generated upchirp-downchirp CC_UDCH.

A mixer 610 mixes the complex conjugated generated upchirp-downchirp CC_UDCH with the downchirp FIB_DCH to obtain the shifted downchirp FIB_SH_DCH. An angle computation 612 computes the phase angle for each complex sample to the shifted downchirp FIB_SH_DCH, e.g. by computing the arctangent of the in-phase component divided by the quadrature component or coordinate rotation digital computer (CORDIC), to obtain an estimated phase angle PA. A unwrap step 613 unwraps the estimated phase angle PA, e.g. corrects discontinuities due to angle transitions from 359° to 0° or −180° to +180°, to obtain an unwrapped shifted downchirp UW_DCH.

A filter 614 filters the signal of unwrapped shifted downchirp UW_DCH based on the fiber delay value FDV, to estimate the phase noise of the distributed-feedback semiconductor laser (301 in FIG. 3). Then the filter 614 obtains the phase noise estimate PNE, based on the estimate of the phase noise of the distributed-feedback semiconductor laser and the normalized frequency value NFVD indicative of the distance to target, e.g. the delay caused by the distance to target. This estimation of the phase noise is performed with knowledge of how the phase noise changes during propagation through the system 300.

In the embodiment of FIG. 6, the unwrap step 613 uses the phase angle PA to rotate the I and Q components of the shifted downchirp FIB_SH_DCH. The processing algorithm 600 then obtains the phase noise at a fiber delay value FDV and transforms this phase noise to the target delay value RTT.

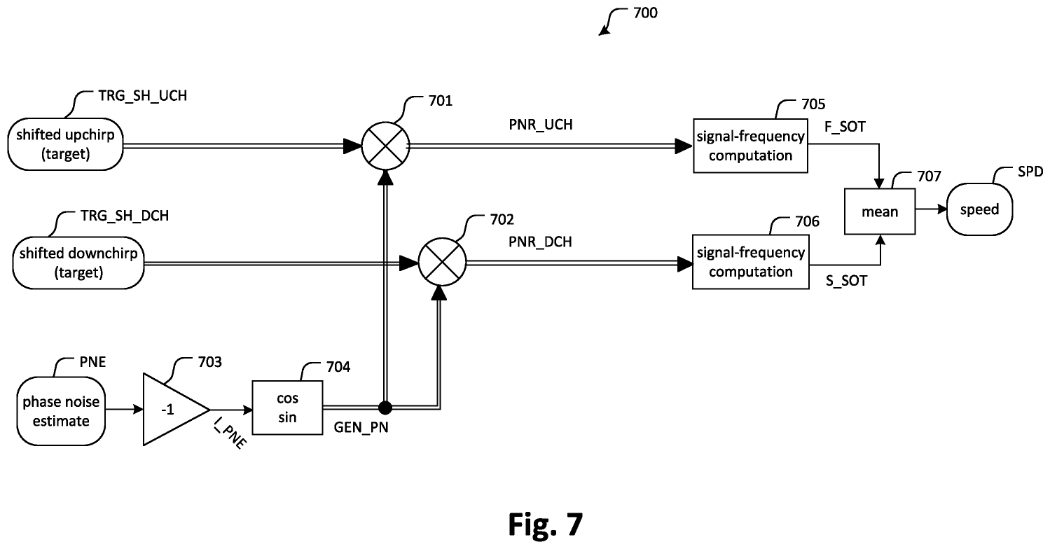

FIG. 7 schematically shows an embodiment of a processing algorithm 700 to obtain the speed of the target using a FMCW Lidar system 300 of FIGS. 3, 4, 5 and 6.

An inverting step 703 inverts the sign of the phase noise estimate PNE (also in FIG. 6) to obtain an inverted phase noise I_PN. A function generator 704 generates, based on the inverted phase noise I_PN, a generated inverted phase noise GEN_PN.

A mixer 701 mixes the shifted target upchirp TRG_SH_UCH (also in FIG. 5) with the generated inverted phase GEN_PN to obtain a phase noise reduced shifted upchirp PNR_UCH. A signal-frequency computation 705 computes the frequency of the signal, e.g. by transforming the phase noise reduced shifted upchirp PNR_UCH with a fast Fourier Transformation, finding the frequency peak and determining the central frequency of the frequency peak. The signal-frequency computation 705 extracts a first frequency indicative of the Doppler shift due to the targets speed. A first speed of the target F_SOT is calculated from the first frequency indicative of the Doppler shift.

Similarly, a mixer 702 mixes the shifted target downchirp TRG_SH_DCH (also in FIG. 5) with the generated inverted phase noise GEN_PN to obtain a phase noise reduced shifted downchirp PNR_DCH. A signal-frequency computation 706 computes the frequency of the signal, e.g. by transforming the phase noise reduced shifted downchirp PNR_DCH with a fast Fourier Transformation, finding the frequency peak and determining the central frequency of the frequency peak. The signal-frequency computation 706 extracts a second frequency indicative of the Doppler shift due to the targets speed. A second speed of the target S_SOT is calculated from the second frequency indicative of the Doppler shift.

A mean calculator 707 calculates the mean of the first speed of the target F_SOT and the second speed of the target S_SOT, thus obtaining the speed SPD of the target.

FIG. 8 schematically shows a FMCW Lidar system 800 for the measurement of speed and distance of a target 807 according to an embodiment.

The FMCW Lidar system 800 and FMCW Lidar system of FIG. 9a use a double side band modulator with suppressed carrier to generate the transmit signal. They need optical band pass filters or arrayed waveguide gratings to separate lower and upper sideband in the local oscillator path.

The coherent receive elements in FMCW Lidar system 800 and FMCW Lidar system of FIG. 3 are optical hybrids that generate two outputs for I (In-phase) and Q (Quadrature) components.

These outputs can be processed as a complex-valued signal. Eight balanced photodetectors are required for the whole system (I and Q, up-chirp and down-chirp, target and reference path).

A distributed-feedback semiconductor laser 801 generates a laser beam LB with a carrier frequency having a linewidth of e.g. 10 MHz and transmits the laser beam LB to an intensity modulator with double sideband and a suppressed carrier (IM DSB SC) 802. A Frequency generator 803 generates a linearly chirped electrical signal LCE that chirps e.g. from 24 GHz to GHz over a 20 μs time period. The Frequency generator 803 transmits the linearly chirped electrical signal LCE to an amplifier 804. The amplifier 804 amplifies the linearly chirped electrical signal LCE, to obtain an amplified linearly chirped electrical signal A_LCE.

The intensity modulator with double sideband and a suppressed carrier 802 receives the laser beam LB from the distributed-feedback semiconductor laser 801 and the amplified linearly chirped electrical signal A_LCE as inputs. The intensity modulator with double sideband and a suppressed carrier 802 outputs a reduced carrier intensity, a 1^{st} order upper sideband CUSB that chirps e.g. from carrier frequency plus 24 GHz up to carrier frequency plus 25 GHz and a 1^{st} order lower sideband CLSB that chirps e.g. from carrier frequency minus 24 GHz down to carrier frequency minus 25 GHz, therefore obtaining a suppressed carrier, an upchirp and a downchirp.

Intensity modulator with double sideband and a suppressed carrier 802 modulates the laser beam LB of the distributed-feedback semiconductor laser 801 with the amplified linearly chirped electrical signal A_LCE. Through the method of intensity modulation an upper and a lower sideband is created. Finally, the carrier frequency is suppressed. The setup of FIG. 8 with an Intensity modulator with double sideband and a suppressed carrier 802 can simultaneously generate a chirping upper sideband CUSB and the chirping lower sideband CLSB. The simultaneously generated chirping upper sideband CUSB and chirping lower sideband CLSP have anti-correlated signal phases and fully correlated phase noise.

An erbium-doped fiber amplifier 805 amplifies the suppressed carrier, the chirping upper sideband CUSB and the chirping lower sideband CLSB as the emittance signal EMI. Optics 806 emit the emittance signal EMI onto the target 807, where it is reflected the reflected signal REFL is obtained. Other optics 808 receive the reflected signal REFL and output the reflected signal REFL to optical hybrids 810 and 812.

When the emittance signal EMI, emitted from optics 806 is reflected on the target it becomes a reflected signal REFL, and is received by the optics 808. The distance to the target has imparted a time delay relative to the reference chirping upper sideband CUSB and the chirping lower sideband CLSP onto the reflected signal REFL. If the target is moving relative to the FMCW Lidar system 800, the target can also impart a shift in frequency onto the reflected signal REFL due to the Doppler effect.

Optical band pass filter (OBPF) 809 filters the emittance signal EMI and obtains the reference chirping upper sideband CUSB. Similarly, optical band pass filter (OBPF) 811 filters the emittance signal EMI and obtains the reference chirping lower sideband CLSB.

Optical hybrid 810 combines the reflected signal REFL from optics 808 and the reference chirping upper sideband CUSB, once directly and once with a 90°-phase shift, to obtain an in-phase signal I_USB of the upper sideband and a quadrature signal Q_USB of the upper sideband. Balanced photo diodes 814 convert the in-phase signal I_USB and quadrature signal Q_USB into respective electrical signals. Analog-to-digital converters (ADC) 815 convert the electrical signals into respective digital signals and transmit the digital signals to the processor 816.

Optical hybrid 812 combines the reflected signal REFL from optics 808 and the reference chirping lower sideband CLSB, once directly and once with a 90°-phase shift, to obtain an in-phase signal I_LSB of the lower sideband and a quadrature signal Q_LSB of the lower sideband. Balanced photo diodes 817 convert the in-phase signal I_LSB and quadrature signal Q_LSB into respective electrical signals. Analog-to-digital converters (ADC) 818 convert the electrical signals into respective digital signals and transmit the digital signals to the processor 816.

The time delay of the reflected signal REFL causes the chirping upper sideband CUSB and the chirping lower sideband CLSP of the reflected signal REFL to lag behind the reference chirping upper sideband CUSB from the optical band pass filter 809 and the reference chirping lower sideband CLSP from the optical band pass filter 811, respectively. The chirping upper sideband CUSB of the reflected signal is at lower frequency than the reference chirping upper sideband CUSB inputted into the optical hybrid 810. This is due to the increasing frequency of the chirping upper sideband CUSB. When the chirping upper sideband CUSB of the reflected signal and the reference chirping upper sideband CUSB interfere a beat frequency develops due to the difference in frequency. This beat frequency is indicative of the distance to the target.

Non-zero target speeds produce an additional effect for the reflected chirping lower sideband CLSP and the reference chirping lower sideband CLSP. However, the Doppler effect shifts the frequencies of the reflected chirping upper sideband CUSB and chirping lower sideband CLSP in the same direction. Thus, the frequency difference between either the reflected and the reference chirping upper sideband CUSB decreases while the difference between the reflected and the reference chirping lower sideband CLSP increases or vice versa.

The digital signals obtained from analog-to-digital converters (ADC) 815, 818 are further processed by processor a 816 in order to determine the distance and the relative speed of target 807. Examples of the processing of the digital signals by processor 816 are explained in more detail with regard to FIGS. 5 to 7.

A fiber delay 813 delays the emittance signal EMI and obtains a delayed emittance signal with a defined time delay as a fiber delay reference FDR. In detection circuitry 819 detection similar to the detection of the components 810, 812, 814, 815, 817 and 818 is performed. Dual optical hybrids combine either the reference chirping upper sideband CUSB from the optical band pass filter 809 or the reference chirping lower sideband CLSB from the band pass filter 811 with the fiber delay reference FDR from the fiber delay 813. Balanced photo diodes (BPD) convert the combined signals into respective electrical signals and analog-to-digital converters (ADC) convert the electrical signals into respective digital signals. The digital signals are transmitted the processor 816. The exemplifying detection performed within the detection circuitry 819 is described with regard to FIG. 4.

The emittance reference signal ERS form the fiber enables a reference measurement of phase noise in the processor 816. Thus, it is possible to calculate and subtract the phase noise that emerges in the processing of the reflected up- and downchirps.

With the FMCW Lidar system 800 it is possible to measure both the distance and the relative speed of a target as will be described with reference to FIG. 5 to 7.

FIG. 9a schematically shows a FMCW Lidar system 900 for the measurement of speed and distance of a target 907 according to an embodiment.

The FMCW Lidar system 900 and FMCW Lidar system of FIG. 8 use a double side band modulator with suppressed carrier to generate the transmit signal. They need optical band pass filters or arrayed waveguide gratings to separate lower and upper sideband in the local oscillator path.

The FMCW Lidar system 900 needs acousto-optical frequency shifters in the local oscillator paths. They replace the optical hybrids of systems 300 and 800. The photodetector signals are real-valued. System 900 needs half the number of photodetectors and analogue to digital converters compared to systems 300 and 800.

A distributed-feedback semiconductor laser 901 generates a laser beam LB with a carrier frequency having a linewidth of e.g. 10 MHz and transmits the laser beam LB to an intensity modulator with double sideband and a suppressed carrier (IM DSB SC) 902. A Frequency generator 903 generates a linearly chirped electrical signal LCE that chirps e.g. from 24 GHz to GHz over a 20 μs time period and transmits it to an amplifier 904. Amplifier 904 amplifies the linearly chirped electrical signal LCE, to obtain an amplified linearly chirped electrical signal A_LCE.

Intensity modulator with double sideband and a suppressed carrier 902 receives the laser beam LB from the distributed-feedback semiconductor laser 901 and the amplified linearly chirped electrical signal A_LCE as inputs. Intensity modulator with double sideband and a suppressed carrier 902 outputs a reduced carrier intensity, a 1^{st} order upper sideband CUSB that chirps e.g. from carrier frequency plus 24 GHz up to carrier frequency plus 25 GHz and a 1^{st} order lower sideband CLSB that chirps e.g. from carrier frequency minus 24 GHz down to carrier frequency minus 25 GHz, therefore obtaining a suppressed carrier, a chirping upper sideband CUSB and a chirping lower sideband CLSB.

Intensity modulator with double sideband and a suppressed carrier 902 modulates the laser beam LB of the distributed-feedback semiconductor laser 901 with the amplified linearly chirped electrical signal LCE. The setup of FIG. 9a with an intensity modulator with double sideband and a suppressed carrier 902 can simultaneously generate a chirping upper sideband CUSB and chirping lower sideband CLSB. The simultaneous chirping upper sideband CUSB and the chirping lower sideband CLSP generated this way have anti-correlated signal phases and fully correlated phase noise.

An erbium-doped fiber amplifier 905 amplifies the suppressed carrier, the chirping upper sideband CUSB and the chirping lower sideband CLBS as the emittance signal EMI. Optics 906 emits the emittance signal EMI onto the target 907, where it is reflected and becomes the reflected signal REFL. Other optics 908 receives the reflected signal REFL and outputs the reflected signal REFL to the balanced photo diodes 914 and 917.

When the emittance signal EMI, emitted from optics 906 is reflected on the target and becomes the reflected signal REFL, and is received by optics 908 the distance to the target has imparted a time delay relative to the reference chirping upper sideband CUSB and the reference chirping lower sideband CLSB onto the reflected signal REFL. If the target is moving relative to the FMCW Lidar system 900, the target can also impart a shift in frequency onto the reflected signal due to the Doppler effect.

Optical band pass filter (OBPF) 909 filters the emittance signal EMI and obtains the reference chirping upper sideband CUSB. An acousto-optical frequency shifter (AOFS+) 910 increases the frequency of the reference chirping upper sideband CUSB, to obtain a shifted reference chirping upper sideband CUSB. Similarly, optical band pass filter 911 filters the emittance signal EMI and obtains the reference chirping lower sideband CLSB. An acousto-optical frequency shifter (AOFS-) 910 decreases the frequency of the reference chirping lower sideband CLSB, obtaining a shifted reference chirping lower sideband CLSB.

Balanced photo diode 914 converts the shifted reference chirping upper sideband CUSB interfered with the reflected signal REFL into an electrical signal. Analog-to-digital converter (ADC) 915 convert the electrical signal into a digital signal and transmit the digital signal to the processor 916.

Balanced photo diode 917 converts the shifted reference chirping lower sideband CLSB interfered with the reflected signal REFL into an electrical signal. Analog-to-digital converter (ADC) 918 convert the electrical signal into a digital signal and transmit the digital signal to the processor 916.

The digital signals obtained from analog-to-digital converters (ADC) 915, 918 are transmitted to the processor 916 as a target upchirp TRG_UCH and a target downchirp TRG_DCH. The target upchirp TRG_UCH and the target downchirp TRG_DCH are further processed by processor a 916 in order to determine the distance and the relative speed of a target 907. Examples of the processing of the digital signals by processor 916 are explained in more detail with regard to FIGS. 10 to 12.

The time delay of the reflected signal REFL causes the chirping upper sideband CUSB and the chirping lower sideband CLSB of the reflected signal REFL to lag behind the reference upchirp and the reference chirping lower sideband CLSB, respectively, which are inputted into the balanced photo diodes 914 and 917. The chirping upper sideband CUSB of the reflected signal REFL is at lower frequency than the reference chirping upper sideband CUSB inputted into the balanced photo diodes 914. This is due to the increasing frequency of the chirping upper sideband CUSB. When the chirping upper sideband CUSB of the reflected signal and the reference chirping upper sideband CUSB interfere a beat frequency develops due to the frequency difference. This beat frequency is indicative of the distance to the target.

Non-zero target speeds produce an additional effect for the reflected chirping lower sideband CLSB and the reference chirping lower sideband CLSB. However, the Doppler effect shifts the frequencies of the reflected upchirp and chirping lower sideband CLSB in the same direction. Thus, the frequency difference between either the reflected and the reference chirping upper sideband CUSB decreases while the difference between the reflected and the reference chirping lower sideband CLSB increases or vice versa.

A fiber delay 913 delays the emittance signal EMI and obtains a delayed emittance signal with a defined time delay as a fiber delay reference FDR. In detection circuitry 919 detection similar to the detection of the components 914, 915, 917 and 918 is performed. Balanced photo diodes (BPD) convert combined reference chirping upper sideband CUSB from the acousto-optical frequency shifter (AOFS+) 910 or the reference chirping lower sideband CLSP from the acousto-optical frequency shifter (AOFS−) 912 with the fiber delay reference FDR from the fiber delay 913 into respective electrical signals. Analog-to-digital converters (ADC) convert the electrical signals into respective digital signals. The digital signals are transmitted the processor 916. The exemplifying detection performed within the detection circuitry 919 is described with regard to FIG. 9b.

The fiber delay reference FDR from the fiber enables a reference measurement of phase noise in the processor 916. Thus, it is possible to calculate and subtract the phase noise that emerges in the processing of the reflected chirping upper sideband CUSB and chirping lower sideband CLSB.

With the FMCW Lidar system 900 it is possible to measure both the distance and the relative speed of a target as will be described with reference to FIGS. 10, 11 and 12.

FIG. 9b schematically shows in more detail an embodiment of detection circuitry 919, as it is utilized in FIG. 9a.

Balanced photo diode 1021 converts the shifted reference chirping upper sideband CUSB interfered with emittance reference signal into an electrical signal. Analog-to-digital converter (ADC) 1023 converts the electrical signal into a digital signal and transmits the digital signal to the processor 916.

Balanced photo diode 1022 converts the shifted reference chirping lower sideband CUSB interfered with emittance reference signal into an electrical signal. Analog-to-digital converter (ADC) 1024 converts the electrical signal into a digital signal and transmits the digital signal to the processor 916.

The digital signals obtained from analog-to-digital converters (ADC) 1023, 1024 are transmitted to the processor 916 as a fiber upchirp FIB_UCH and a fiber downchirp FIB_DCH. The target upchirp TRG_UCH and the target downchirp TRG_DCH are further processed by processor a 916 in order to determine a phase noise estimate to cancel the phase noise in the measurement of the distance and the relative speed of target 907. Examples of the processing of the digital signals by processor 916 are explained in more detail with regard to FIGS. 10 to 12.

Fiber delay reference FDR from the fiber delay 913 and the chirping upper sideband CUSB from the acousto-optical frequency shifter (AOFS+) 910 as a reference upchirp do not interfere upon being combined since the coherence length of the signals is smaller than the delay introduced by the fiber delay 913. This makes it possible to extract the phase noise introduced by the distributed-feedback semiconductor laser 901.

In general, the processing done in the dual BPD detector ADC 919 is the same as the processing done by the components 914, 915, 917, 918 in FIG. 9a.

FIG. 10 schematically shows a processing algorithm 1000 carried out by a processor (916 in FIGS. 9a and 9b) to measure a distance to a target and estimate the speed of the target using the FMCW Lidar system 900 according to the embodiments of FIGS. 9a and 9b.

A target upchirp TRG_UCH and a target downchirp TRG_DCH are inputs to the processing algorithm 1000. The inputs are provided, as can be seen in FIGS. 9a and 9b, by the ADCs 915 and 918 to the processor 916. The doubled arrows signify that the transmitted signal has an in-phase (I) and a quadrature (Q) component and single line arrows signify real numbered signals.

A positive Hilbert transformation 1003 transforms the upchirp TRG_UCH to obtain a positively transformed upchirp PT_UCH. Another positive Hilbert transformation 1005 transforms the downchirp TRG_DCH to obtain a positively transformed downchirp PT_DCH. Similarly, a negative Hilbert transformation 1009 transforms the upchirp TRG_UCH to obtain a negatively transformed upchirp NT_UCH.

A mixer 1004 mixes the positively transformed upchirp PT_UCH with the positively transformed downchirp PT_DCH to obtain a mixed upchirp-downchirp MX_UDCH. A mixer 1006 mixes the mixed upchirp-downchirp MX_UDCH with a −2*100 MHz signal SH1 to obtain a shifted mixed upchirp-downchirp SHMX_UDCH, this shift undoes the effect of the AOFS+(910 in FIG. 9a) and AOFS-(912 in FIG. 9a). A decimation filter 1011 filters the shifted mixed upchirp-downchirp SHMX_UDCH to obtain a filtered shifted mixed upchirp-downchirp FSHMX_UDCH. A signal-frequency computation 1012 is used to compute the frequency of the filtered shifted mixed upchirp-downchirp FSHMX_UDCH, e.g. by transforming the the filtered shifted mixed upchirp-downchirp FSHMX_UDCH with a fast Fourier Transformation, finding the frequency peak and determining the central frequency of the frequency peak. The signal-frequency computation 1012 obtains a frequency value FVD indicative of the distance to the target. A normalizing step 1013 normalizes the frequency value FVD to obtain a normalized frequency value NFVD indicative of the distance to the target. A mixer 1014 mixes the normalized frequency value NFVD with a −100 MHz signal SH2 to obtain a shifted normalized frequency value SH_NFVD. The frequency value FVD and the normalized frequency value NFVD can further be used to compute the distance from the FMCW Lidar system (900 in FIGS. 9a and 9b) to the target object (907 in FIG. 9a).

A function generator 1016 generates, based on the shifted normalized frequency value SH_NFVD, an upchirp-downchirp representative of the shifted range-to-target signal with decreased noise, as a generated upchirp-downchirp GEN_UDCH. The generated upchirp-downchirp GEN_UDCH is complex conjugated 1017 to obtain a complex conjugated generated upchirp-downchirp CC_UDCH.

A mixer 1008 mixes the complex conjugated generated upchirp-downchirp CC_UDCH with the positively transformed downchirp PT_DCH to obtain a shifted downchirp TRG_SH_DCH. Similarly, a mixer 1010 mixes the generated upchirp-downchirp GEN_UDCH with the negatively transformed upchirp NT_UCH to obtain a shifted upchirp TRG_SH_UCH.

A speed estimation 1018 estimates, based on the shifted target upchirp TRG_SH_UCH and the shifted target downchirp TRG_SH_DCH, the speed of the target, obtaining the estimated speed SPD.

As described with reference to FIG. 9 the upchirp TRG_UCH and a downchirp TRG_DCH both contain a beat frequency indicative of the time delay between the reflected signal from the optics 908 and the reference upchirp or the reference downchirp. This beat frequency is extracted in the mixer 1004 and estimated in the signal-frequency computation 1012. The normalized frequency value NFVD can be calculated from the beat frequency. The function generator 1016 generates a signal with the same beat, that is however reduced in noise as the generated upchirp-downchirp GEN_UDCH.

The mixer 1008 mixes the complex conjugated generated upchirp-downchirp CC_UCH with the positively transformed downchirp PT_DCH. The beat frequency indicative of the time delay between the reflected signal from the optics (908 in FIG. 9) and the reference downchirp and containing a frequency shift due to the Doppler effect is mixed with the complex conjugated generated upchirp-downchirp CC_UDCH without a frequency shift due to the Doppler effect. The resulting shifted downchirp TRG_SH_DCH has a frequency that is indicative of the Doppler shift DSF due to the targets speed. This is similarly the case for the shifted upchirp TRG_SH_UCH.

The speed estimation 1018 can extract the frequencies indicative of the Doppler shift DSF, e.g.via a fast Fourier Transformation and estimate a speed SPD from this frequency DSF.

A Hilbert Transformation 1003, 1005 and 1009 shifts all frequencies of a signal by 900 in phase. In which direction the phase shift occurs defines the positive or negative Hilbert Transformation.

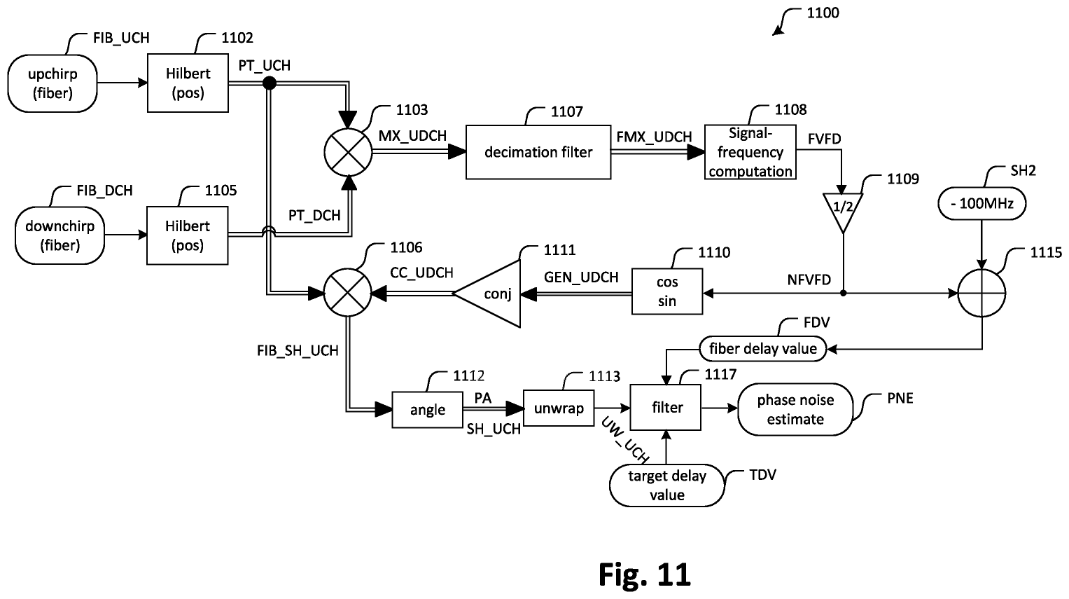

FIG. 11 schematically shows a processing algorithm 1100 carried out by a processor (916 in FIGS. 9a and 9b) to estimate phase noise on signals of a FMCW Lidar system 900 according to the embodiments of FIGS. 9a and 9b.

A fiber upchirp FIB_UCH and a fiber downchirp FIB_DCH from the fiber delay (913 in FIG. 9a und 9b) are inputs to the processing algorithm 1100. The inputs are provided, as can be seen in FIG. 9b, by the ADCs 1023 and 1024 to the processor 916. The doubled arrows signify that the transmitted signal has an in-phase (I) and a quadrature (Q) component and single line arrows signify real numbered signals.

A positive Hilbert transformation 1002 transforms the upchirp FIB_UCH to obtain a positively transformed upchirp PT_UCH. Similarly, positive Hilbert transformation 1105 transforms the downchirp FIB_DCH obtaining a positively transformed downchirp PT_DCH.

A mixer 1103 mixes the positively transformed upchirp PT_UCH with the positively transformed downchirp PT_UCH to obtain a mixed upchirp-downchirp MX_UDCH. A decimation filter 1107 filters the mixed upchirp-downchirp MX_UDCH to obtain a filtered mixed upchirp-downchirp FMX_UDCH. A signal-frequency computation 1108 is used to compute the frequency of the filtered mixed upchirp-downchirp FMX_UDCH e.g. by transforming the filtered mixed upchirp-downchirp FMX_UDCH with a fast Fourier Transformation, finding the frequency peak and determining the central frequency of the frequency peak. The signal-frequency computation 1108 obtains a frequency value FVFD indicative of the delay imposed by the fiber delay (913 in FIG. 9a). A normalizing step 1109 normalizes the frequency value FVFD to obtain a normalized frequency value NFVFD. A mixer 1115 mixes the normalized frequency value NFVFD with a −100 MHz signal SH2 to obtain fiber delay value FDV. The frequency value FVFD and the normalized frequency value NFVFD can further be used to compute the length of the fiber delay (913 in FIG. 9a).

A function generator 1110 generates, based on the halved-fiber-delay-range FDR, an upchirp-downchirp representative of the halved-fiber-delay-range FDR with decreased noise, as a generated upchirp-downchirp GEN_UDCH. The generated upchirp-downchirp GEN_UDCH is complex conjugated 1111 to obtain a complex conjugated generated upchirp-downchirp CC_UDCH.

A mixer 1106 mixes the complex conjugated generated upchirp-downchirp CC_UDCH with the positively transformed upchirp PT_UCH to obtain the shifted upchirp FIB_SH_UCH. An angle estimation 1112 estimates, based on the shifted upchirp FIB_SH_UCH, a phase angle to obtain the estimated phase angle PA. A unwrap step 1113 unwraps the shifted upchirp FIB_SH_UCH, based on the estimated phase angle, to obtain an unwrapped shifted upchirp UW_UCH.

A filter 1117 filters the signal of unwrapped shifted downchirp UW_UCH based on the fiber delay value FDV, to estimate the phase noise of the distributed-feedback semiconductor laser (901 in FIG. 9a). Then the filter 1117 obtains the phase noise estimate PNE, based on the estimate of the phase noise of the distributed-feedback semiconductor laser and the normalized frequency value NFVD indicative of the distance to target, e.g. the delay caused by the distance to target. This estimation of the phase noise is performed with knowledge of how the phase noise changes during propagation through the system 900.

In an embodiment of FIG. 11, the unwrap step 1113 uses the phase angle PE to rotate the I and Q components of the shifted upchirp FIB_SH_UCH. The processing algorithm 1100 then obtains the phase noise PE at a fiber delay value FDV and transforms this phase noise to the target delay value TDV, when the target is ranged in FIG. 9a.

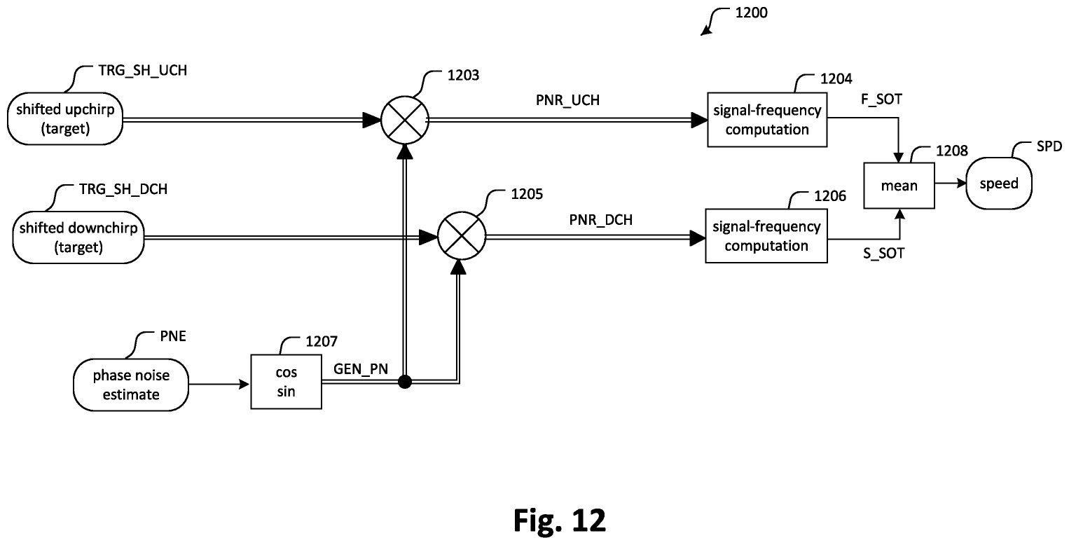

FIG. 12 schematically shows a processing algorithm 1200 to obtain the speed of the target using a FMCW Lidar system 900 according to an embodiment of FIGS. 9a and 9b.

A function generator 1207 generates, based on the phase noise estimate PNE (also FIG. 11), a generated phase noise GEN_PN. A mixer 1203 mixes the shifted target upchirp TRG_SH_UCH (also in FIG. 11) with the generated phase noise GEN_PN to obtain a phase noise reduced shifted upchirp PNR_UCH. A signal-frequency computation 1204 computes the frequency of the phase noise reduced shifted upchirp PNR_UCH, e.g. by transforming the phase noise reduced shifted upchirp PNR_UCH with a fast Fourier Transformation, finding the frequency peak and determining the central frequency of the frequency peak. The signal-frequency computation 1204 extracts a first frequency indicative of the Doppler shift F_FDS due to the targets speed. A first speed of the target F_SOT is calculated from the first frequency indicative of the Doppler shift F_FDS.

Similarly, a mixer 1205 mixes the shifted target downchirp TRG_SH_DCH (also in FIG. 10) with the generated noise GEN_PN to obtain phase noise reduced shifted downchirp PNR_DCH. A signal-frequency computation 1206 computes the frequency of the phase noise reduced shifted upchirp PNR_DCH, e.g. by transforming the phase noise reduced shifted upchirp PNR_DCH with a fast Fourier Transformation, finding the frequency peak and determining the central frequency of the frequency peak. The signal-frequency computation 1206 extracts a second frequency indicative of the Doppler shift S_FDS due to the targets speed. A second speed of the target S_SOT is calculated from the second frequency indicative of the Doppler shift S_FDS.

A mean calculator 1208 calculates the mean of the first speed of the target F_SOT and the second speed of the target S_SPT, thus obtaining the speed SPE of the target.

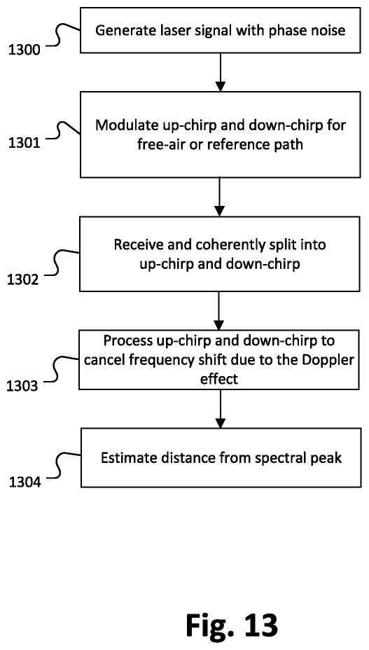

FIG. 13 schematically shows a flowchart of a distance measurement using a FMCW Lidar system 300, 800 or 900 according to an embodiment.

At 1300, a laser signal with phase noise is generated by a distributed-feedback semiconductor laser 301, 801 or 901 with a carrier frequency having a linewidth of 10 MHz. At 1301, the laser signal is modulated to obtain a generated signal including an up-chirp and a down-chirp. The generated signal is emitted to a target and reflected at the target, obtaining a reflected signal. At 1302, the reflected signal is received from the target. Two reference signals containing either only the upchirp or the downchirp are generated from the generated signal. A free-air or reference path introduces a time delay between the emitted reflected signal and the reference signals. The reflected signals and the reference signals are interfered respectively, obtaining a combined upchirp signal and a combined downchirp signal.

At 1303, the combined upchirp signal and a combined downchirp signal are processed to cancel the frequency shift due to the Doppler effect, obtaining a mixed upchirp-downchirp signal.

At 1304, a signal frequency is computed, e.g. by transforming the mixed upchirp-downchirp signal with a fast Fourier Transformation, finding the frequency peak and determining the central frequency, which is indicative of the distance to target, of the frequency peak.

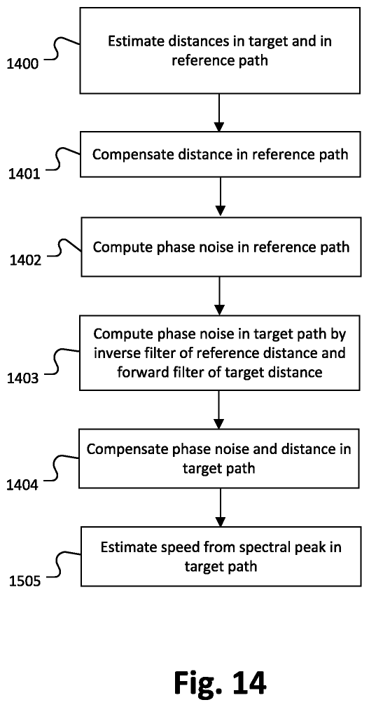

FIG. 14 schematically shows a flowchart of a speed measurement using a FMCW Lidar system 300, 800 or 900 according to an embodiment.

At 1400, distances in target and in reference path are estimated. At 1401, the distance in reference path, which was calculated before, is compensated, e.g. with frequency shift of the signal frequency, to obtain a signal that is centered at a frequency of zero Hertz. At 1402, phase noise in reference path is computed. One reference path includes the glass fiber as a delay, which is longer than the coherence length of the laser beam LB, the chirping upper sideband CUSB and the chirping lower sideband. Thus, upon combination of the fiber delay reference FDR with the reference chirping upper sideband CUSB and the reference chirping lower sideband CLSB the signals do not interfere.

At 1403, phase noise in target path is computed from the phase noise in the reference path by inverse filter of reference distance and forward filter of target distance. At 1404, the phase noise and distance in the target path is compensated. At 1405, the speed from spectral peak in target path is estimated.

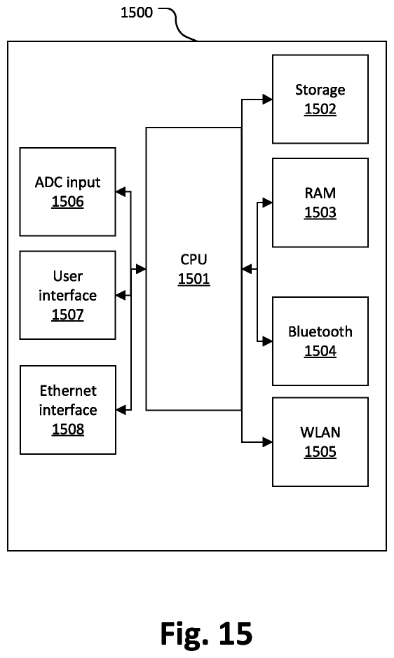

FIG. 15 schematically describes an embodiment of an FMCW Lidar system device that can implement the processor (317 in FIG. 3, 816 in FIG. 8, 916 in FIGS. 9a and 9b) for processing a distance and speed measurement of a target.

The electronic device 1500 may further implement all other processes of a standard FMCW Lidar system (see FIGS. 5 to 7 and 10 to 12), like I-Q value determination, phase, amplitude, confidence, and reflectance determination. The electronic device 1500 comprises a CPU 1501 as processor. The electronic device 1500 further comprises an ADC input 1506 connected to the processor 1501. The processor 1501 may for example implement the determination of distance and speed of a target (see FIGS. 5 to 7 and 10 to 12). The electronic device 1500 further comprises a user interface 1507 that is connected to the processor 1501. This user interface 1507 acts as a man-machine interface and enables a dialogue between an administrator and the electronic system. For example, an administrator may make configurations to the system using this user interface 1507. The electronic device 1500 further comprises a Bluetooth interface 1504, a WLAN interface 1505, and an Ethernet interface 1508. These units 1504, 1505 act as I/O interfaces for data communication with external devices. For example, video cameras with Ethernet, WLAN or Bluetooth connection may be coupled to the processor 1501 via these interfaces 1504, 1505, and 1508. The electronic device 1500 further comprises a data storage 1502, and a data memory 1503 (here a RAM). The data storage 1502 is arranged as a long-term storage, e.g. for storing the algorithm parameters for one or more use-cases, for recording data received from the ADC. The data memory 1503 is arranged to temporarily store or cache data or computer instructions for processing by the processor 1501.

It should be recognized that the embodiments, e.g. FIGS. 5, 6, 8, 10, 11, and 12, describe processes, respectively methods with an exemplary ordering of process steps. The specific ordering of process steps is, however, given for illustrative purposes only and should not be construed as binding. It should also be noted that the division of the systems into units is only made for illustration purposes and that the present disclosure is not limited to any specific division of functions in specific units.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure. Note that the present technology can also be configured as described below.
(1) A measurement system comprising circuitry configured to determine a phase noise cancelled speed measurement (SPD) based on interference of a chirping upper single sideband (CUSB) and a fiber delay reference (FDR) and based on interference of a chirping lower single sideband (CLSB) and the fiber delay reference (FDR).
(2) A measurement system of (1), wherein the phase noise cancelled speed measurement (SPD) is further based on interference of a chirping upper single sideband (CUSB) and a reflected signal (REFL) and is further based on interference of a chirping lower single sideband (CLSB) and the reflected signal (REFL).
(3) The measurement system of (1) or (2), wherein the chirping upper single sideband (CUSB) and the chirping lower single sideband (CLSB) are generated simultaneously.
(4) The measurement system of (1) to (3), wherein the chirping upper single sideband (CUSB) and the chirping lower single sideband (CLSB) have anti-correlated signals and fully correlated phase noise.
(5) The measurement system of (1) to (4), wherein the chirping upper single sideband (CUSB) and the chirping lower single sideband (CLSB) are detected in separate balanced photo diodes (313, 315; 403, 405; 910, 912; 1014, 1017, 1121, 1122).
(6) The measurement system of (1) to (5), wherein the fiber delay reference (FDR) is obtained by a fiber delay (310, 913, 1013) configured to delay an input signal (C_CSB, EMI).
(7) The measurement system of (6), wherein the input signal (C_CSB, EMI) is obtained based on the chirping upper single sideband (CUSB) and the chirping lower single sideband (CLSB).
(8) The measurement system of (1) to (7), wherein the phase noise cancelled speed measurement (SPD) is obtained based on a phase noise estimate (PNE) that is determined by interference of a chirping upper single sideband (CUSB) and the fiber delay reference (FDR) and by interference of a chirping lower single sideband (CLSB) and the fiber delay reference (FDR).
(9) The measurement system of (1) to (8), wherein the phase noise cancelled speed measurement (SPD) is obtained based on a fiber upchirp (FIB_UCH) and a fiber downchirp (FIB_UCH), and a target delay value (NFVD).
(10) The measurement system of (1) to (9), wherein a phase noise cancelled speed measurement (SPD) is obtained based on phase noise estimate (PNE), wherein the phase noise estimate (PNE) is determined based on a fiber upchirp (FIB_UCH) and a fiber downchirp (FIB_UCH), and a target delay value (NFVD), wherein the fiber upchirp (FIB_UCH) is determined by interference of a chirping upper single sideband (CUSB) and a fiber delay reference (FDR) and the fiber downchirp (FIB_DCH) is determined by interference of a chirping lower single sideband (CLSB) and the fiber delay reference (FDR).
(11) The measurement system of (1) to (10), wherein the circuitry comprises an optical hybrid (311, 312, 401, 402; 910, 912) configured to combine the fiber delay reference (FDR) with chirping upper single sideband (CUSB) or the fiber delay reference (FDR) with the chirping lower single sideband (CLSB), once directly and once with a 900 phase shift, to obtain an in-phase signal (I_USB, I_LSB) and a quadrature signal (Q_USB, I_USB).
(12) The measurement system of (1) to (11), wherein the chirping upper single sideband (CUSB) and the chirping lower single sideband (CLSB) are generated by sideband modulation of a laser beam (LB).
(13) The measurement system of (1) to (12), wherein two single sideband optical modulation (302, 303), driven by a linearly chirping electrical signal (LCE) generate the chirping upper single sideband (CUSB) and the chirping lower single sideband (CLSB).
(14) The measurement system of (1) to (13), wherein the phase noise cancelled speed measurement (SPD) is obtained based on the phase noise estimate (PNE), a shifted target upchirp signal (TRG_SH_UCH) and a shifted target downchirp signal (TRG_SH_DCH), wherein the shifted target upchirp signal (TRG_SH_UCH) and the shifted target downchirp signal (TRG_SH_DCH) are determined by shifting a target upchirp signal (TRG_UCH) and, respectively, a target downchirp signal (TRG_DCH).
(15) The measurement system of (1) to (14), wherein the fiber delay reference (FDR) is determined based on delaying a signal comprising the chirping upper single sideband (CUSB) and the chirping lower single sideband (CLSB).
(16) The measurement system of (14), wherein the target upchirp signal (TRG_UCH) is shifted based on mixing the target upchirp signal (TRG_UCH) with a complex conjugated generated upchirp and downchirp signal (CC_UDCH) and the target downchirp signal (TRG_DCH) is shifted based on mixing the target downchirp signal (TRG_DCH) with a generated upchirp and downchirp signal (GEN_UDCH).
(17) The measurement system of (14) to (16), wherein the target upchirp signal (TRG_UCH) is determined based on interference of a chirping upper single sideband (CUSB) and a reflection signal (REFL) and the target downchirp signal (TRG_DCH) is determined based on interference of a chirping lower single sideband (CLSB) and the reflection signal (REFL).
(18) The measurement system of (17), wherein the chirping upper single sideband (CUSB) and the chirping lower single sideband (CLSB) are generated based on sideband modulation of a laser beam (LB).
(19) The measurement system of (17) or (18), wherein the reflection signal (REFL) is determined based on reflecting a signal comprising the chirping upper single sideband (CUSB) and the chirping lower single sideband (CLSB) off a target (308; 907; 1007).
(20) The measurement system of (14), wherein the phase noise cancelled speed measurement (SPD) is obtained based on mixing the shifted target upchirp signal (TRG_SH_UCH) with a generated phase noise signal (GEN_PN), which is based on the phase noise estimate (PNE), and based on mixing shifted target downchirp signal (TRG_SH_DCH) with the generated phase noise signal (GEN_PN), which is based on the phase noise estimate (PNE).
(21) The measurement system of (5), wherein the phase noise estimate (PNE) is determined based on a fiber delay phase noise (FDPN) and a target delay value (NFVD), wherein the fiber delay phase noise (FDPN) is determined based on a shifted fiber upchirp signal (FIB_SH_UCH) and/or a shifted fiber downchirp signal (FIB_SH_DCH) and a fiber delay value (FDV).
(22) The measurement system of (21), wherein the fiber delay value (FDV) is determined based on the fiber upchirp signal (FIB_UCH) and the fiber downchirp signal (FIB_UCH).
(23) The measurement system of (21) or (22), wherein the shifted fiber upchirp signal (FIB_SH_UCH) is determined based on the fiber upchirp signal (FIB_UCH) and the fiber downchirp signal (FIB_DCH), and wherein the shifted fiber downchirp signal (FIB_SH_UCH) is determined based on the fiber upchirp signal (FIB_UCH) and the fiber downchirp signal (FIB_DCH).
(24) The measurement system of any one of (1) to (23), wherein the circuitry further comprises a processor (317, 916, 1016) configured to analyse digital signals from a measurement path and reference paths and obtain a distance and a speed of a target as well as a phase noise of the laser beam (LB).
(25) An automotive measurement system comprising circuitry configured to determine a distance to and a phase noise cancelled speed measurement (SPD) of a target object (308; 807; 907) wherein the phase noise cancelled speed measurement is obtained based on a phase noise estimate (PNE), a chirping upper single sideband (CUSB) and a chirping lower single sideband (CLSB), wherein the chirping upper sideband (CUSB) and the chirping lower sideband (CLSB) are generated simultaneously.
(26) The automotive measurement system of (25), wherein the phase noise cancelled speed measurement (SPD) is further based on interference of a chirping upper single sideband (CUSB) and a reflected signal (REFL) and is further based on interference of a chirping lower single sideband (CLSB) and the reflected signal (REFL).
(27) The automotive measurement system of (25) or (26), wherein the chirping upper single sideband (CUSB) and the chirping lower single sideband (CLSB) have anti-correlated signals and fully correlated phase noise.
(28) The automotive measurement system of (25) to (27), wherein the chirping upper single sideband (CUSB) and the chirping lower single sideband (CLSB) are detected in separate balanced photo diodes (313, 315; 403, 405; 910, 912; 1014, 1017, 1121, 1122).
(29) The automotive measurement system of (25) to (28), wherein the fiber delay reference (FDR) is obtained by a fiber delay (310, 913, 1013) configured to delay an input signal (C_CSB, EMI).
(30) The automotive measurement system of (29), wherein the input signal (C_CSB, EMI) is obtained based on the chirping upper single sideband (CUSB) and the chirping lower single sideband (CLSB).
(31) The automotive measurement system of (25) to (30), wherein the phase noise cancelled speed measurement (SPD) is obtained based on a phase noise estimate (PNE) that is determined by interference of a chirping upper single sideband (CUSB) and the fiber delay reference (FDR) and by interference of a chirping lower single sideband (CLSB) and the fiber delay reference (FDR).
(32) The automotive measurement system of (25) to (31), wherein the phase noise cancelled speed measurement (SPD) is obtained based on a fiber upchirp (FIB_UCH) and a fiber downchirp (FIB_UCH), and a target delay value (NFVD).
(33) The automotive measurement system of (25) to (32), wherein a phase noise cancelled speed measurement (SPD) is obtained based on phase noise estimate (PNE), wherein the phase noise estimate (PNE) is determined based on a fiber upchirp (FIB_UCH) and a fiber downchirp (FIB_UCH), and a target delay value (NFVD), wherein the fiber upchirp (FIB_UCH) is determined by interference of a chirping upper single sideband (CUSB) and a fiber delay reference (FDR) and the fiber downchirp (FIB_DCH) is determined by interference of a chirping lower single sideband (CLSB) and the fiber delay reference (FDR).
(34) The automotive measurement system of (25) to (33), wherein the circuitry comprises an optical hybrid (311, 312, 401, 402; 910, 912) configured to combine the fiber delay reference (FDR) with chirping upper single sideband (CUSB) or the fiber delay reference (FDR) with the chirping lower single sideband (CLSB), once directly and once with a 900 phase shift, to obtain an in-phase signal (I_USB, I_LSB) and a quadrature signal (Q_USB, I_USB).
(35) The automotive measurement system of (25) to (34), wherein the chirping upper single sideband (CUSB) and the chirping lower single sideband (CLSB) are generated by sideband modulation of a laser beam (LB).
(36) The automotive measurement system of (25) to (35), wherein two single sideband optical modulation (302, 303), driven by a linearly chirping electrical signal (LCE) generate the chirping upper single sideband (CUSB) and the chirping lower single sideband (CLSB).
(37) The automotive measurement system of (25) to (36), wherein the phase noise cancelled speed measurement (SPD) is obtained based on the phase noise estimate (PNE), a shifted target upchirp signal (TRG_SH_UCH) and a shifted target downchirp signal (TRG_SH_DCH), wherein the shifted target upchirp signal (TRG_SH_UCH) and the shifted target downchirp signal (TRG_SH_DCH) are determined by shifting a target upchirp signal (TRG_UCH) and, respectively, a target downchirp signal (TRG_DCH).
(38) The automotive measurement system of (25) to (37), wherein the fiber delay reference (FDR) is determined based on delaying a signal comprising the chirping upper single sideband (CUSB) and the chirping lower single sideband (CLSB).
(39) The automotive measurement system of (25) to (38), wherein the target upchirp signal (TRG_UCH) is shifted based on mixing the target upchirp signal (TRG_UCH) with a complex conjugated generated upchirp and downchirp signal (CC_UDCH) and the target downchirp signal (TRG_DCH) is shifted based on mixing the target downchirp signal (TRG_DCH) with a generated upchirp and downchirp signal (GEN_UDCH).
(40) The automotive measurement system of (37), wherein the target upchirp signal (TRG_UCH) is determined based on interference of a chirping upper single sideband (CUSB) and a reflection signal (REFL) and the target downchirp signal (TRG_DCH) is determined based on interference of a chirping lower single sideband (CLSB) and the reflection signal (REFL).
(41) The automotive measurement system of (40), wherein the chirping upper single sideband (CUSB) and the chirping lower single sideband (CLSB) are generated based on sideband modulation of a laser beam (LB).
(42) The automotive measurement system of (40) or (41), wherein the reflection signal (REFL) is determined based on reflecting a signal comprising the chirping upper single sideband (CUSB) and the chirping lower single sideband (CLSB) off a target (308; 907; 1007).
(43) The automotive measurement system of (39), wherein the phase noise cancelled speed measurement (SPD) is obtained based on mixing the shifted target upchirp signal (TRG_SH_UCH) with a generated phase noise signal (GEN_PN), which is based on the phase noise estimate (PNE), and based on mixing shifted target downchirp signal (TRG_SH_DCH) with the generated phase noise signal (GEN_PN), which is based on the phase noise estimate (PNE).
(44) The automotive measurement system of (28), wherein the phase noise estimate (PNE) is determined based on a fiber delay phase noise (FDPN) and a target delay value (NFVD), wherein the fiber delay phase noise (FDPN) is determined based on a shifted fiber upchirp signal (FIB_SH_UCH) and/or a shifted fiber downchirp signal (FIB_SH_DCH) and a fiber delay value (FDV).
(45) The automotive measurement system of (44), wherein the fiber delay value (FDV) is determined based on the fiber upchirp signal (FIB_UCH) and the fiber downchirp signal (FIB_UCH).
(46) The automotive measurement system of (44) to (45), wherein the shifted fiber upchirp signal (FIB_SH_UCH) is determined based on the fiber upchirp signal (FIB_UCH) and the fiber downchirp signal (FIB_DCH), and wherein the shifted fiber downchirp signal (FIB_SH_UCH) is determined based on the fiber upchirp signal (FIB_UCH) and the fiber downchirp signal (FIB_DCH).
(47) The automotive measurement system of (25) to (46), wherein the circuitry further comprises a processor (317, 916, 1016) configured to analyse digital signals from a measurement path and reference paths and obtain a distance and a speed of a target as well as a phase noise of the laser beam (LB).
(48) The automotive measurement system of (45) to (47), wherein the distance to the target object (308; 807; 907) is determined based on the fiber delay value (FDV).
(49) A measurement method comprising determining a phase noise cancelled speed measurement (SPD) based on interference of a chirping upper single sideband (CUSB) and a fiber delay reference (FDR) and based on interference of a chirping lower single sideband (CLSB) and the fiber delay reference (FDR).
(50) A automotive measurement method comprising determining a distance to and a phase noise cancelled speed measurement (SPD) of a target object (308; 807; 907) based on a phase noise estimate (PNE), a chirping upper single sideband (CUSB) and a chirping lower single sideband (CLSB), wherein the chirping upper sideband (CUSB) and the chirping lower sideband (CLSB) are generated simultaneously.

1. A measurement system comprising circuitry configured to determine a phase noise cancelled speed measurement based on interference of a chirping upper single sideband and a fiber delay reference and based on interference of a chirping lower single sideband and the fiber delay reference.

2. The measurement system of claim 1, wherein the chirping upper single sideband and the chirping lower single sideband are generated simultaneously.

3. The measurement system of claim 1, wherein the chirping upper single sideband and the chirping lower single sideband have anti-correlated signals and fully correlated phase noise.

4. The measurement system of claim 1, wherein the chirping upper single sideband and the chirping lower single sideband are detected in separate balanced photo diodes.

5. The measurement system of claim 1, wherein the fiber delay reference is obtained by a fiber delay configured to delay an input signal.

6. The measurement system of claim 5, wherein the input signal is obtained based on the chirping upper single sideband and the chirping lower single sideband.

7. The measurement system of claim 1, wherein the phase noise cancelled speed measurement is obtained based on a phase noise estimate that is determined based on interference of a chirping upper single sideband and the fiber delay reference and based on interference of a chirping lower single sideband and the fiber delay reference.

8. The measurement system of claim 1, wherein the phase noise cancelled speed measurement is obtained based on a fiber upchirp and a fiber downchirp, and a target delay value.

9. The measurement system of claim 1, wherein a phase noise cancelled speed measurement is obtained based on phase noise estimate, wherein the phase noise estimate is determined based on a fiber upchirp and a fiber downchirp, and a target delay value, wherein the fiber upchirp is determined by interference of a chirping upper single sideband and a fiber delay reference and the fiber downchirp is determined by interference of a chirping lower single sideband and the fiber delay reference.

10. The measurement system of claim 1, wherein the circuitry comprises an optical hybrid configured to combine the fiber delay reference with chirping upper single sideband or the fiber delay reference with the chirping lower single sideband, once directly and once with a 900 phase shift, to obtain an in-phase signal and a quadrature signal.

11. The measurement system of claim 1, wherein the chirping upper single sideband and the chirping lower single sideband are generated by sideband modulation of a laser beam.

12. The measurement system of claim 1, wherein two single sideband optical modulation, driven by a linearly chirping electrical signal generate the chirping upper single sideband and the chirping lower single sideband.

13. The measurement system of claim 1, wherein the phase noise cancelled speed measurement is obtained based on the phase noise estimate, a shifted target upchirp signal and a shifted target downchirp signal, wherein the shifted target upchirp signal and the shifted target downchirp signal are determined by shifting a target upchirp signal and, respectively, a target downchirp signal.

14. The measurement system of claim 13, wherein the target upchirp signal is shifted by mixing the target upchirp signal with a complex conjugated generated upchirp and downchirp signal and the target downchirp signal is shifted by mixing the target downchirp signal with a generated upchirp and downchirp signal.

15. The measurement system of claim 1, wherein the chirping upper single sideband and the chirping lower single sideband are generated by sideband modulation of a laser beam.

16. The measurement system of claim 5, wherein the phase noise estimate is determined based on a fiber delay phase noise and a target delay value, wherein the fiber delay phase noise is determined based on a shifted fiber upchirp signal and/or shifted fiber downchirp signal (FIB_SH_DCH) and a fiber delay value.

17. The measurement system of claim 1, wherein the circuitry further comprises a processor configured to analyse digital signals from a measurement path and reference paths and obtain a speed of a target as well as a phase noise of the laser beam.

18. An automotive measurement system comprising circuitry configured to determine a distance to and a phase noise cancelled speed measurement of a target object wherein the phase noise cancelled speed measurement is obtained based on a phase noise estimate, a chirping upper single sideband and a chirping lower single sideband, wherein the chirping upper sideband and the chirping lower sideband are generated simultaneously.

19. A measurement method comprising determining a phase noise cancelled speed measurement based on interference of a chirping upper single sideband and a fiber delay reference and based on interference of a chirping lower single sideband and the fiber delay reference.
